(19) United States
(12) Patent Application Publication
(10) Pub. No.: US 2026/0339323 A1
(43) Pub. Date: Oct. 29, 2026

(54) REMOTE OPERATIONS MANAGEMENT

(71) Applicant: NVIDIA Corporation, Santa Clara, CA (US)

(72) Inventors: Xingqiang WU, San Jose, CA (US); Vito MAGNANIMO, Munchen (DE); Mustafa BILGEN, Brookline, MA (US); Eric WINDER, Novi, MI (US); Aingara PARAMAKURU, Pickering (CA); William ARMSTRONG, Rochester, MN (US)

(21) Appl. No.: 19/193,500

(22) Filed: Apr. 29, 2025

(51) Int. Cl. G05D 1/227; B60W 30/06

(52) U.S. Cl. CPC G05D 1/227; B60W 30/06

(57) ABSTRACT

The present disclosure relates system and methods configured to improve safety of remote operation. In some embodiments, a machine or an ego-machine may perform one or more operations in a remote operating mode based at least on one or more remote control commands received wirelessly via a wireless communication system. In some embodiments, the remote control system of the ego-machine may be disabled in response to a switch command to switch the ego-machine from operating in the remote operating mode to operating in a local operating mode. In some embodiments, the disabling may include blocking or disabling at least wireless communications from reaching the remote control system of the ego-machine. The ego-machine may perform one or more local operations in the local operating mode based at least on one or more local control commands.

### BACKGROUND

Machines and systems that perform autonomous and semi-autonomous operations, which may be referred to herein as “ego-machines”, may perform various tasks with reduced user supervision. For example, in the context of an ego-machine as a vehicle or robot, the vehicle or robot may perform certain operations, such as navigation, acceleration, braking, obstacle detection, collision avoidance, traffic signal recognition, parking, route planning, remote parking, pick and place, object manipulation, among others, without or with reduced user supervision.

Machines, such as autonomous or semi-autonomous machines and robots, include various subsystems and/or components configured to perform such operations or functionalities. Such systems and functionalities-when combined-allow the machines to perform operations. For example, a machine may include a powertrain system (e.g., engine, transmission, drivetrain, etc.), a brake system (e.g., anti-lock braking system (ABS), electronic stability control, etc.), a steering system (e.g., power steering, rack and pinion, etc.), a suspension system (e.g., shock absorbers and struts, front and rear suspension, etc.), a fuel system (e.g., fuel tank, fuel pump, fuel injectors, etc.), an electrical system (e.g., battery, alternator, wiring and connectors, etc.), a cooling system (e.g., radiator, thermostat, coolant, etc.), safety systems (e.g., airbags, seatbelts, advanced-driver-assistance systems (ADAS), etc.), a climate control system (e.g., heating, ventilation, and air-conditioning (HVAC), etc.), an end-effector or manipulator system, among others that may operate together to facilitate operation of the vehicle, machine, or robot.

The operations or functionalities performed by the computing entities may include different types of operations. For example, the operations may include local operations and remote operations. The local operations may refer to activities and/or functions involved in operating a machine during normal operations. The remote operations—e.g., teleoperations—may refer to the ability to control or interact with the machine from a remote location, such as outside or away from the machine. Such remote operations may provide convenience to the user as the user may cause the machine to perform operations from a distance.

However, such remote operations may increase certain risks for the machines. For example, the remote operations may increase or include security vulnerabilities. For example, the wireless connection established between the remote control device and the machine may provide an avenue for malicious parties (e.g., hackers, etc.) to access data corresponding to the machine and/or to take control of the machine via the connection. Some existing approaches of reducing such risks include encryption of communication; however, such approaches have only provided limited protection against certain types of attacks and may be subject to other attacks.

### SUMMARY

According to one or more embodiments of the present disclosure, systems and methods may be configured to improve safety of remote or tele-operation. In particular, the embodiments of the present disclosure may help reduce chances of unauthorized parties accessing the main control system of a machine via a remote control or teleoperation system. For example, the remote control system of the machine may be switched or turned off after remote operations are performed, such that the unauthorized parties may not use the established wireless connection to access the main control system of the machine. In some embodiments, a machine or an ego-machine may perform one or more operations in a remote operating mode based at least on one or more remote control commands received wirelessly via a wireless communication system. In some embodiments, the remote control commands received via the wireless control system may be interpreted by and/or delivered to a main control system of the ego-machine via a remote control system. In some embodiments, the remote control system may be a part of the main control system.

In some embodiments, the remote control system may be disabled in response to a switch command to switch the ego-machine from operating in the remote operating mode to operating in a local operating mode. The disabling may include blocking or disabling at least wireless communication from reaching the remote control system of the ego-machine. In some embodiments, the ego-machine may perform one or more local operations in the local operating mode based at least on one or more local control commands.

### BRIEF DESCRIPTION OF THE DRAWINGS

The present systems and methods for reducing security vulnerabilities associated with remote or tele-operations are described in detail below with reference to the attached figures, wherein:

FIG. 1 is a diagram illustrating an example computing environment for reducing security vulnerabilities associated with remote or tele-operations of a machine, in accordance with one or more embodiments of the present disclosure;

FIG. 2 illustrates a flow diagram for a method of switching to a remote operating mode, in accordance with one or more embodiments of the present disclosure;

FIG. 3 illustrates a flow diagram for a method of switching to a local operating mode, in accordance with one or more embodiments of the present disclosure;

FIG. 4 illustrates a flow diagram for a method of switching between remote operating mode and a local operating mode, in accordance with one or more embodiments of the present disclosure;

FIG. 5A is an example of sensor locations having corresponding fields of view or sensory fields for example autonomous or semi-autonomous machines, in accordance with at least some embodiments of the present disclosure;

FIG. 5B is an illustration of an example of component and sensor locations on an autonomous or semi-autonomous vehicle, in accordance with at least some embodiments of the present disclosure;

FIG. 5C is a block diagram of an example system architecture for an autonomous or semi-autonomous vehicle, robot, and/or other machine type, in accordance with at least some embodiments of the present disclosure;

FIG. 5D is a block diagram of an example architecture of a computing system—such as a system-on-a-chip (SoC)—in accordance with at least some embodiments of the present disclosure;

FIG. 5E is a system diagram for communication between cloud-based server(s) and an example autonomous or semi-autonomous vehicle, robot, and/or other machine type, in accordance with at least some embodiments of the present disclosure;

FIG. 6 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 7 is a block diagram of an example computing system for generative artificial intelligence (AI), in accordance with at least some embodiments of the present disclosure; and

FIG. 8 is a block diagram of an example computing device, in accordance with at least some embodiments of the present disclosure.

### DETAILED DESCRIPTION

One or more embodiments of the present disclosure may relate to controlling and/or restricting particular communication channels established with respect to a main control system of a machine (e.g., an ego-machine, such as a robot, a vehicle, a forklift, an aircraft, a watercraft, etc.). In some embodiments, the particular communication channels may be controlled based at least on control of one or more components of the machine associated with the particular communication channels. For example, in some embodiments, the one or more components of the machine may be shut down such that the particular communication channels may be removed, closed, and/or restricted.

In some embodiments, the shutdown of the one or more components may be determined based at least on an operating mode of the machine. For example, the machine may be configured to switch between a first operating mode and a second operating mode, in which the one or more components are shutdown with the machine operating in the first operating mode and the one or more components operational with the machine operating in the second operating mode. In some embodiments, the first operating mode may include a local operating mode, and the second operating mode may include a remote or tele-operating mode. In these and other embodiments, one or more components (e.g., of a remote control system) configured to communicate remote control commands corresponding to remote operations to a main control system of the machine may be shutdown/offline/etc. during the first operating mode, such that unauthorized parties may not access the main control system via the remote control system with the machine operating in the first operating mode.

One or more embodiments of the present disclosure may help reduce security vulnerabilities associated with remote operations. For example, some traditional approaches of reducing such security vulnerabilities associated with remote operations may include encryption of communication. For example, the machine may be configured to perform the remote operations based on remote commands received from a remote control device. The remote commands may be received via a wireless communication channel established between the remote control device and the machine. The traditional approaches may encrypt all communication between the machine and the remote control device based on certain encryption algorithms, such that the communication may not be intercepted or deciphered by unauthorized parties. Another existing approach may include authentication and authorization. The users providing remote commands may be required to provide one or more forms of verification or authentication such as passwords, passcodes, fingerprints, facial recognitions, among others. Such verification process may help verify the source of remote commands.

However, such existing approaches provide limited protection against some types of security attacks. For example, the encryption may not protect metadata associated with encrypted messages. Additionally, encryption keys and/or the authentication credentials may be compromised. For example, social engineering (e.g., phishing attacks) may be used to gain access to the encryption keys and the control system.

By contrast, the systems and methods in accordance with one or more embodiments of the present disclosure may protect the main control system of the machine by removing the communication channels established between a remote control device and the main control system. For example, by shutting down the remote control system configured to relay the remote commands from remote control devices to the main control system, the main control system may be protected, even in instances that the remote control system may be under security attacks. Such an approach may protect the main control system in charge of the main operations of the machine from security vulnerabilities associated with remote operations.

The systems and methods of the present disclosure may be implemented across a variety of different platforms that may generate any sort of applicable output and/or that may use annotations for improvement thereof. For example, the systems and methods may be used to improve software development in various environments, such as cybersecurity environments (e.g., NVIDIA®'s LaunchPad), simulation environments (e.g., NVIDIA®'s Drive SIM®), software development kits (e.g., NVIDIA®'s DriveWorks, NVIDIA®'s OMNIVERSE), software application toolkits (e.g., NVIDIA®'s CUDA® Toolkit), or any other suitable platform for which software may be developed and improved by improving annotations related to outputs produced by the software.

The systems and methods described herein may also be used for a variety of other purposes and implemented in a variety of other systems, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in and/or be used to improve a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using USD data, such as OpenUSD, computer aided design (CAD) data, 2D and/or 3D graphics or design data, and/or other data types), systems implemented at least partially using cloud computing resources, and/or other types of systems.

Further, one or more embodiments of the present disclosure may relate to assessing behavior or outputs associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. In the present disclosure, reference to an “autonomous machine” or “semi-autonomous machine” may include any machine (e.g., vehicle) that may be configured to perform one or more autonomous or semi-autonomous navigation or movement operations. As such, such machines may also include machines in which an operator is required or in which an operator may perform such operations as well.

In some instances and implementations, one or more ML models may be used and/or improved upon (e.g., trained) based on annotations of their corresponding outputs such that the assessment of the annotations and/or corresponding annotators may be used to improve the models themselves. In some embodiments, the ML models may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs—such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the systems and methods described herein may be performed within a simulation environment (e.g., NVIDIA's DriveSIM, NVIDIA's ISAAC GYM, NVIDIA's ISAAC SIM, etc.) using simulated data (e.g., simulated sensor data of simulated sensors of a virtual or simulated machine, simulated system data, etc.). For example, the system(s) described herein may be deployed as hardware-in-the-loop during simulation to test the performance of the availability functionalities described herein. For example, simulated sensor or other data may be used to perform availability and safety analysis, and this information may be used during operation of the virtual machine within the environment. These simulated operations may be used to test performance of the underlying algorithms, systems, and/or processes prior to deploying them in the real-world. In some instances, the simulation may be used to generate synthetic training data. In some embodiments, other methods may be used in addition or alternatively from a simulation to generate synthetic training data. For example, the synthetic training data may be generated using NERFs, Gaussian splat techniques, diffusion models, electrostatic models (e.g., Poisson flow generative models (PFGMs), etc. The synthetic training data (in addition to or alternatively from real-world data) may then be processed to perform availability and/or safety analysis, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a 3D content collaboration platform (e.g., NVIDIA's OMNIVERSE) for industrial digitalization, generative physical AI, and/or other use cases, applications, or services. For example, the content collaboration platform or system may include a system that uses USD (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the systems and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NERF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the systems and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUS, hardware-based DLAs, hardware-based PVAs—which may include one or more VPUs, DMA systems, and/or PPEs, hardware-based OFAs, SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

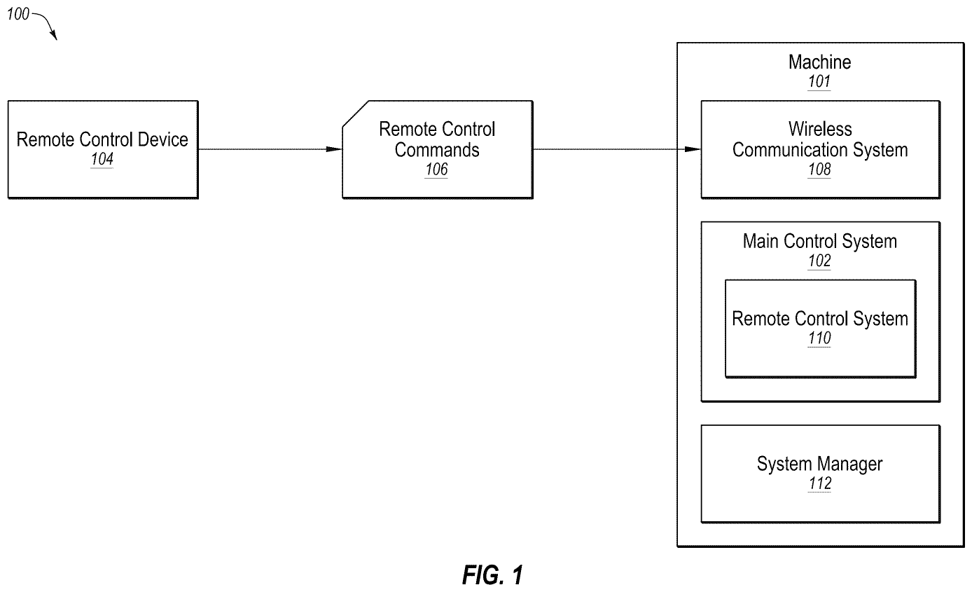

With respect to FIG. 1, FIG. 1 illustrates an example environment 100 related to a system and methods for reducing security vulnerabilities associated with remote operations of a machine, arranged in accordance with one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In general, the environment 100 may include a machine 101 configured to receive one or more remote control commands 106 from a remote control device 104. In some embodiments, the machine 101 may include any system or machine that may perform operations. In the present disclosure, reference to a machine (e.g., the machine 101) may include a reference to any systems or machines that may perform remote operations. Some examples of a machine may include vehicles, autonomous vehicles, semi-autonomous vehicles, watercraft, aircraft, drones, robots (e.g., humanoid, autonomous mobile robot (AMR), forklifts, etc.), automobiles, trucks, buses, bicycles, trains, motorcycles, computing systems, among others.

In some embodiments, the remote control device 104 may include systems or devices that may generate and wirelessly transmit the remote control commands 106 from a remote location. For example, the remote control device 104 may include any suitable device such as a mobile device (e.g., a smartphone, a tablet, a wearable device, etc.), a key fob, a wireless controller, or any other suitable devices. Additionally or alternatively, the remote control device 104 may include a remote center for controlling a group of machines including the machine 101. For example, a command-and-control center may be configured to manage a fleet of machines. The command-and-control center may be a centralized location at which one or more remote operators manage the fleet of machines. In these and other embodiments, the remote control device 104 may provide the remote control commands 106 to the machine 101 wirelessly from a remote location. For example, the remote control device 104 may be at a certain distance away from the machine 101. The certain distance between the machine 101 and the remote control device 104 may vary based on a distance threshold. For example, different remote control devices 104 may have different distance thresholds or distances that the remote control devices 104 may provide the remote control commands 106 to the machine 101 with tolerable amount of interruptions or distortions.

In some embodiments, the remote control commands 106 may include commands or requests to cause the machine 101 to perform remote operations. The remote operations may include operations that the machine 101 may perform without a user physically in the machine 101. For example, the remote operations may include operations such as remote parking, surround-view monitoring, among others.

With respect to remote operations, the remote control device 104 may be configured to communicate with the control systems of the machines wirelessly via wireless networks. For example, the control devices may establish a wireless connection with the control system via WiFi, Bluetooth, cellular networks (e.g., 2G, G, 4G, 5G), or any other suitable types of wireless communication technologies. The wireless connection may help enable remote control of the machines at a distance, allowing the users to conveniently communicate control commands to the machines. For instance, remote parking operations may help with parking and/or unparking the machines in difficult conditions (e.g., bad weather, bad parking conditions, tight spaces, etc.).

In some embodiments, the machine 101 may include a wireless communication system 108 configured to receive the remote control commands 106. For example, the wireless communication system 108 may be configured to obtain the wireless signals or commands. In some embodiments, the wireless communication system 108 may include hardware and/or software configured to establish wireless communication channels and facilitate wireless communications. For example, the wireless communication system 108 may include one or more of a processor, a WiFi chip, a Bluetooth chip, among others.

In some embodiments, the machine 100 may include a main control system 102 configured to manage and coordinate the operation of various subsystems of the machine 100. For example, the main control system 102 may be configured to control the subsystems and/or other processors such that the processors may perform respective functionalities or operations. The main control system 102 may translate high-level planning decisions (e.g., steering decisions, navigation decisions, etc.) into low-level commands that physically move the machine (e.g., operating actuators, etc.).

In these and other embodiments, the main control system 102 may be in charge of facilitating operations of different subsystems of the machine 101 to perform the one or more remote operations based on the remote control commands 106. In some embodiments, the main control system 102 may obtain the remote control commands 106 received using the wireless communication system 108 via a remote control system 110. For example, the wireless communication system 108 may relay the remote control commands 106 to the remote control system 110, which may, in turn, relay the remote control commands 106 to the main control system 102. In some embodiments, the remote control system 110 may be configured to facilitate communication, data transfer, and integration with other systems or subsystems of the machine 101 with respect to the remote control commands 106. For example, the remote control system 110 may be configured to facilitate communication between the wireless communication system 108 and the main control system 102. In some embodiments, the remote control system 110 may be configured to particularly facilitate communications over wireless networks, such as Bluetooth and Wi-Fi. While Bluetooth and Wi-Fi are provided as examples, any other suitable types of wireless networks may be used.

In some embodiments, the main control system 102 and the remote control system 110 may include processors or computing subsystems configured to perform one or more operations. Additionally or alternatively, the main control system 102 and/or the remote control system 110 may be or include virtual machines (VMs). For example, the main control system and/or the remote control system may run as VMs on one or more hypervisors. In some embodiments, the VMs corresponding to the main control system 102 and the remote control system 110 may run on a single physical machine. In other embodiments, the VMs corresponding to the main control system 102 and the remote control system 110 may be run on respective physical machines. In some embodiments, the remote control system 110 may be a part of the main control system 102. For example, the remote control system 110 may be integrated as a functionality or a part of the main control system 110. In some embodiments, the remote control system 110 and the main control system 102 may be implemented as VMs on a same hypervisor.

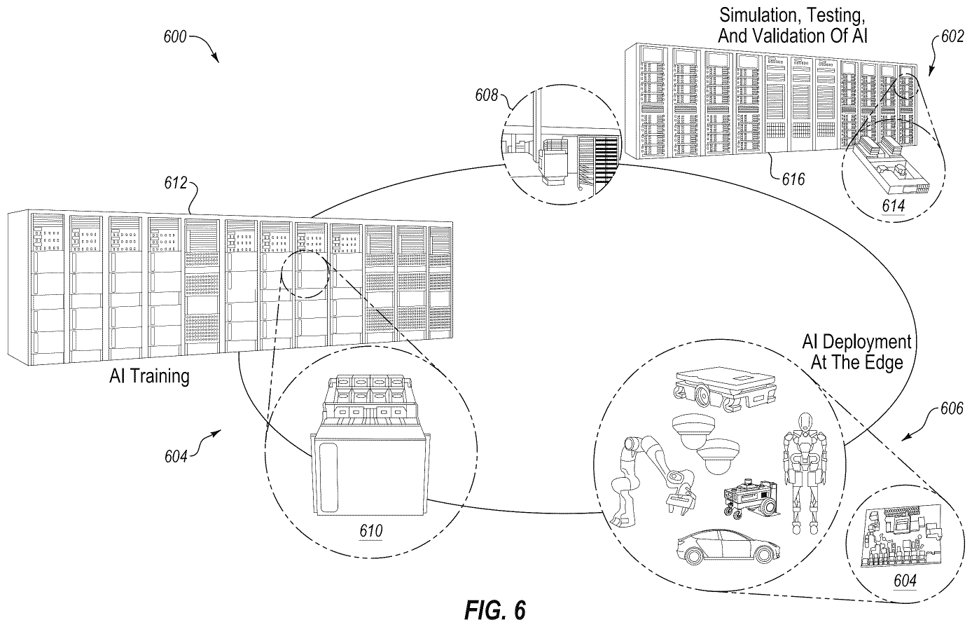

In some embodiments, one or more of the systems and/or processes described herein may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as the computing device described in further detail with respect to FIG. 6.

In some embodiments, the main control system 102 and/or the machine 101 may be configured to operate in different operating modes. In the present disclosure, reference to the machine 101 operating in certain operating modes may also be referring to the main control system 102 operating in such operating modes and causing the machine 101 to perform one or more operations related to such operating modes. The machine 101 may be configured to perform different operations corresponding to different operating modes. For example, the machine 101 may operate in a first operating mode and a second operating mode. In some embodiments, the first operating mode may include a local operating mode (e.g., a local driving mode). The machine 101 in the first operating mode may be configured to perform general operations the machine is designed to perform. For example, with the machine as a vehicle, the vehicle in the first operating mode may perform operations such as driving with a user in the vehicle.

In some embodiments, the second operating mode may include a remote operating mode configured to perform remote operations such as remote parking. The machine 101 operating in the second operating mode may perform the remote operations without the user physically in the machine 101. For example, the machine operating in the second operating mode may perform the remote operations corresponding to the remote control commands 106.

In some embodiments, the machine 101 may switch from the second operating mode to the first operating mode in response to the user command. For instance, a user of the machine 101 may cause the machine 101 to turn on to or switch into the first operating mode. For example, the user may request the machine 101 to operate in the first operating mode. In some embodiments, in response to the request, the remote control system 110 may be turned off. For example, hardware associated with the remote control system may be turned off. Additionally or alternatively, any physical or virtual processors (e.g., remote control VM) configured for remote control may be turned off. For instance, a request may be sent to the main control system or the main control VM to turn off the processors for remote control.

In some embodiments, the machine 101 may include a system manager 112 configured to process shutdown of the remote control system 110. For example, in some embodiments, the system manager 112 may be configured to monitor different systems and/or processors of the machine and manage lives and operations of the systems. The system manager 112 may be responsible for overseeing the operations of the machine 101. For example, the system manager 112 may monitor that the components or subsystems of the machine 101 to identify any issues and to troubleshoot the issues, including shutting down one or more of the components. For example, the system manager 112 may be configured to monitor and shut down the remote control system 110.

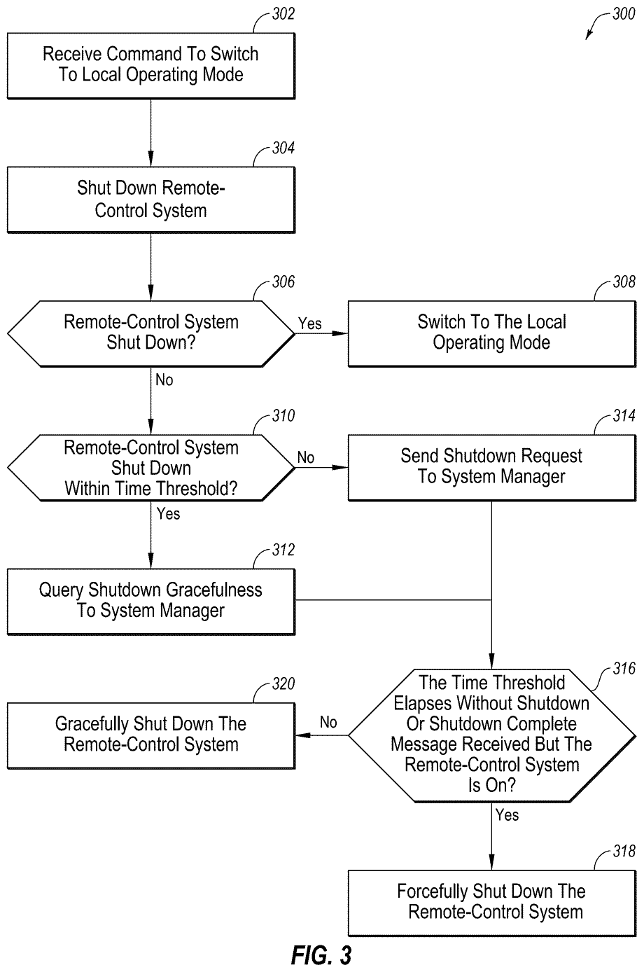

In these and other embodiments, shutting down the remote control system 110 for operating in the first operating mode may help reduce chances of unauthorized parties gaining access to the main operations (e.g., operations performed in the first operating mode such as driving) of the machine. For instance, unauthorized parties may not access the main control system 102 via the wireless communication channel established via the wireless communication system 108 and the remote control system 110. An example shutdown process of the remote control system is described, for example, with respect to FIG. 3 of the present disclosure.

In some embodiments, in response to the wireless communication system 108 receiving the remote control commands 106 from the remote control device 104, the main control system 102 may be notified of the fact that the wireless communication system 108 received the remote control commands 106. In these and other embodiments, the main control system 102 may be only notified of the fact that remote control commands 106 were received without receiving the remote control commands 106 from the wireless communication system 108. In some embodiments, the main control system 102 may be configured to verify that the remote control system 110 was previously shut down gracefully or in a controlled manner. In response to a successful verification of the graceful shutdown, the main control system 102 may turn on the remote control system 110 and switch into the second operating mode.

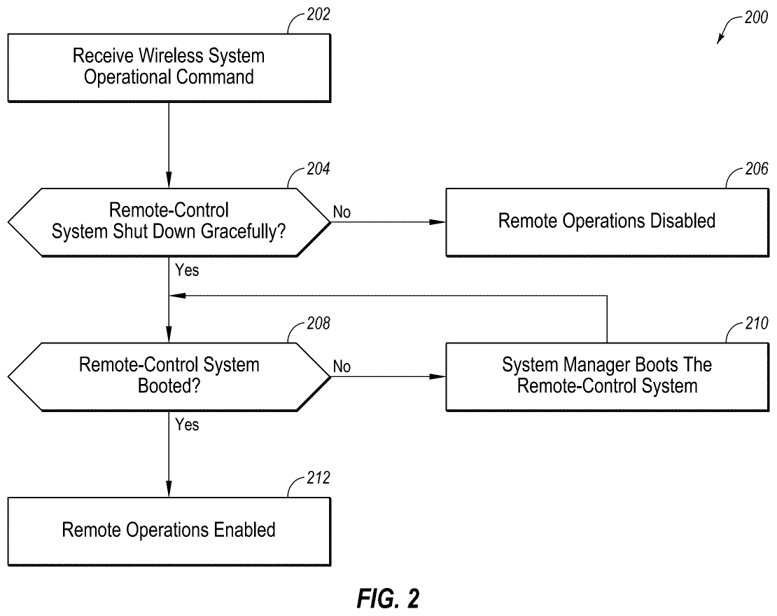

In some embodiments, in response to determining that the communication system was not successfully shut down or the graceful shutdown has not been verified, the main control system 102 may not switch into the second operating mode and the operations corresponding to the remote control commands 106 may not be performed. An example process of running remote operations and verifying the graceful shutdown of the remote control system 110 is discussed in further detail, for example, with respect to FIG. 2 of the present disclosure.

In some embodiments, one or more additional measures may be taken such that the operations associated with the first operating mode may not be affected by the operations associated with the second operating mode. For example, in some embodiments, the resources used by the remote control system 110 may be predefined and/or limited such that operations in the second operating mode do not affect the performance or the capacity of the main control system 102. For example, in instances in which the main control system 102 and the remote control system 110 are run as VMs (e.g., the main VM and remote control VM) using a same processor (e.g., CPU cores), the processor may be partitioned into multiple pools. For example, the processor may be partitioned into a first processor pool and a second processor pool. In some embodiments, the main VM may be operated using a processor pool separated from other VMs associated with remote operations. For example, the main VM may operate using the first processor pool, and the remote control VM or other VMs for remote operations (e.g., drive updates, etc.) may be operated using the second processor pool. The separation of the processor pool may help preserve the processor cores for the operations of the main VM, such that the operations of the main VM are not affected by the operations of the remote control VM. Additionally, the separation may help reduce chances of security breach of the remote control VM affecting the main VM.

Additionally or alternatively, other resources such as memory may be predefined and/or limited for different computing entities. In these and other embodiments, the separation of the resources may allow intended operations of the main control system without interferences from the communication system. In some embodiments, the machine 101 may include a CPU usage limiter. The CPU usage limiter may limit how much CPU computing power the remote control system 110 may consume. For example, the CPU usage limiter may set a usage limit for the remote control system 110. In response to the usage limit being met, the CPU usage may be limited to help prevent the CPU computing power needed to run safety critical tasks being affected. Such limitations may help the main control system 102 to perform critical tasks even in instances the remote control system 110 has issues (e.g., a security breach).

In some embodiments, to reduce chances of sensitive information stored in the memory space associated with the remote control system, the associated memory may be constantly zeroed out or wiped clean. For example, at each reboot of the remote control system 110 (e.g., following a shutdown process), the memory region associated with or allocated to the remote control system 110 may be zeroed out. In some embodiments, additional security measures, such as encrypted communication channels, may be implemented.

In some embodiments, the machine 101 may include a rate limiter configured to limit rates of key management operations from the remote control system 110. The key management operations may include operations related to generating, distributing, storing, and/or exchanging keys for encryptions. A compromised remote control system 110 may request excessive key and crypto operations. For example, the compromised remote control system 110 may perform abnormal or excessive cryptographic operations, such as generating a high number of encryption and decryption requests, excessive key generation or rotation requests, and/or attempting to use the keys in unauthorized or unintended ways. The rate limiter may limit the rate or a number of consecutive key and crypto operations. In response to the number of consecutive key and crypto operations reaching the rate specified by the rate limiter, the operations may be denied. Such limitations may be used to identify potential security breach of the remote control system 110, and the operations of the remote control system 110 may be limited accordingly.

Modifications, additions, or omissions may be made to FIG. 1 without departing from the scope of the present disclosure. For example, the environment 100 may include more or fewer elements than those illustrated and described in the present disclosure.

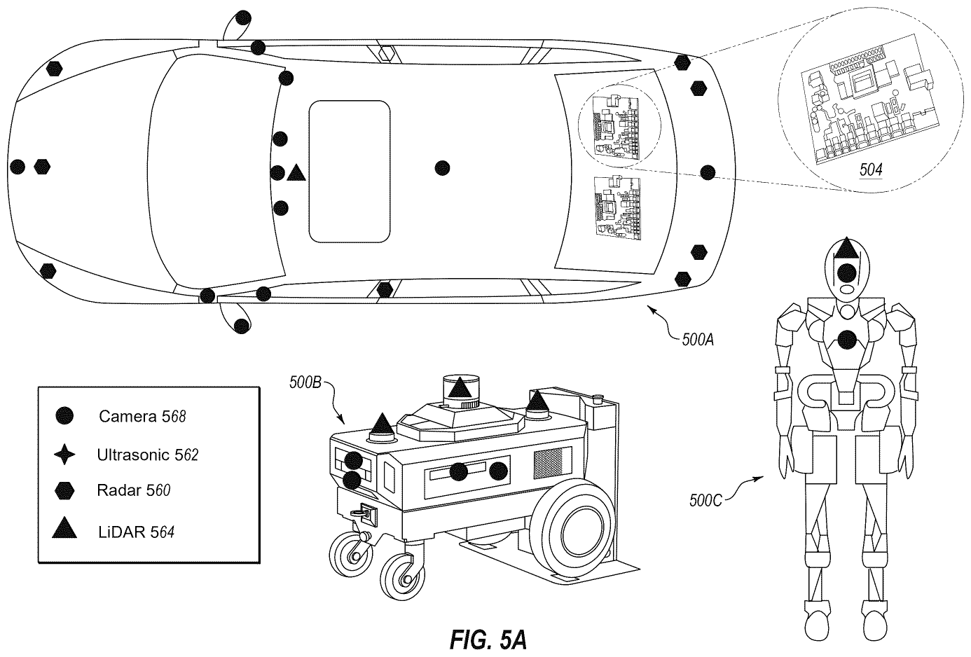

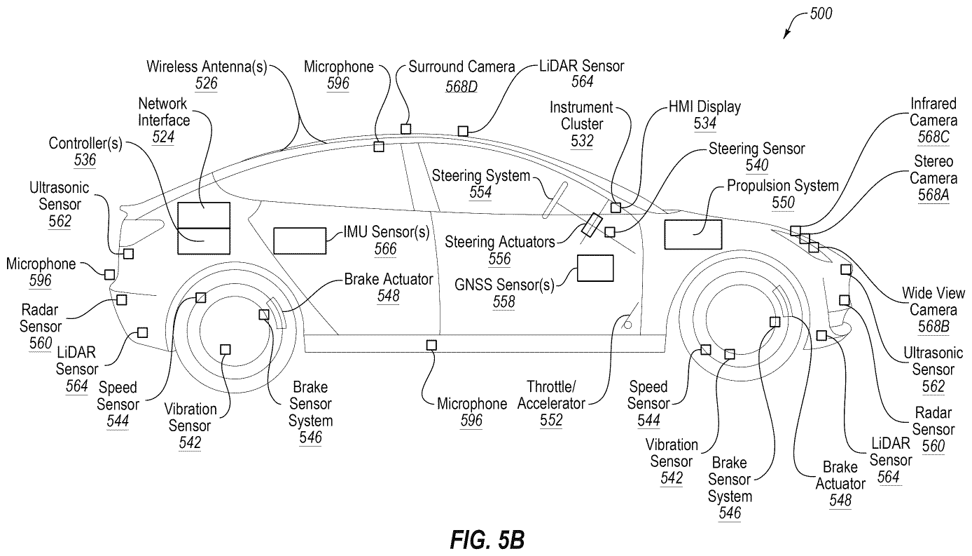

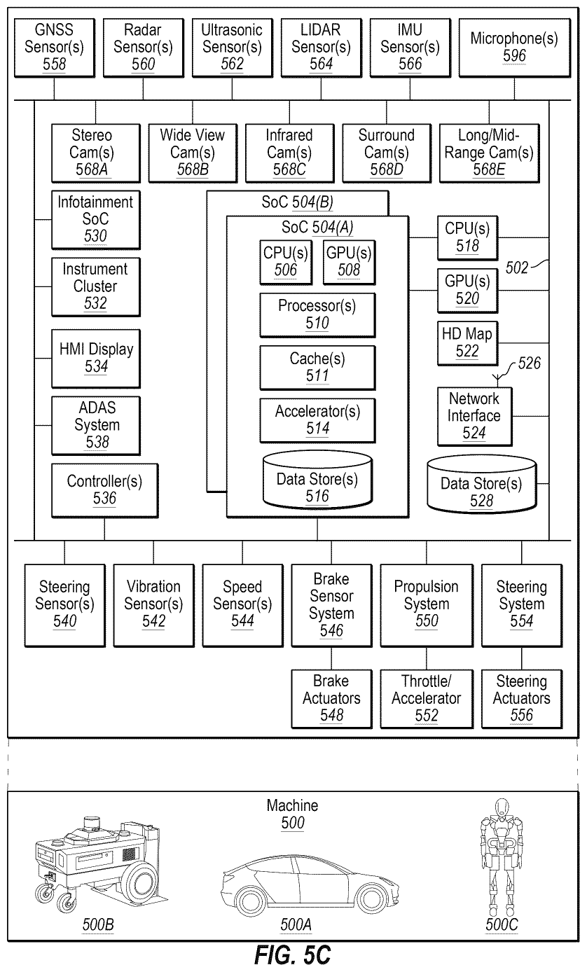

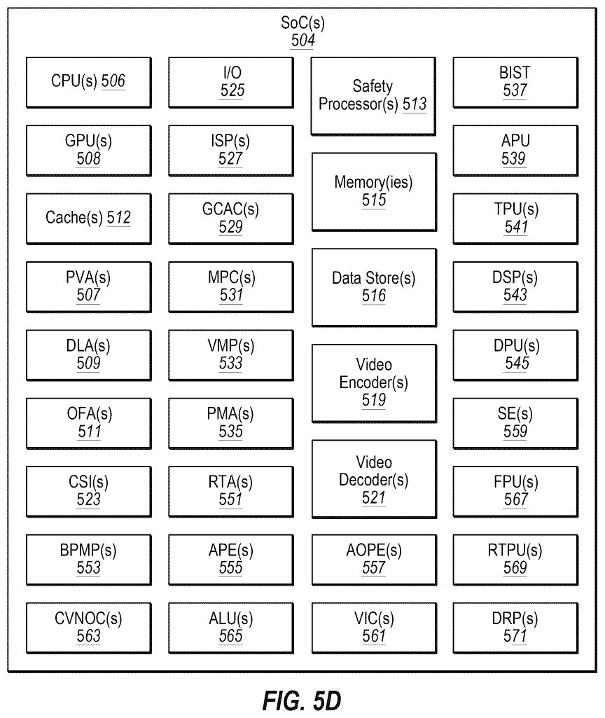

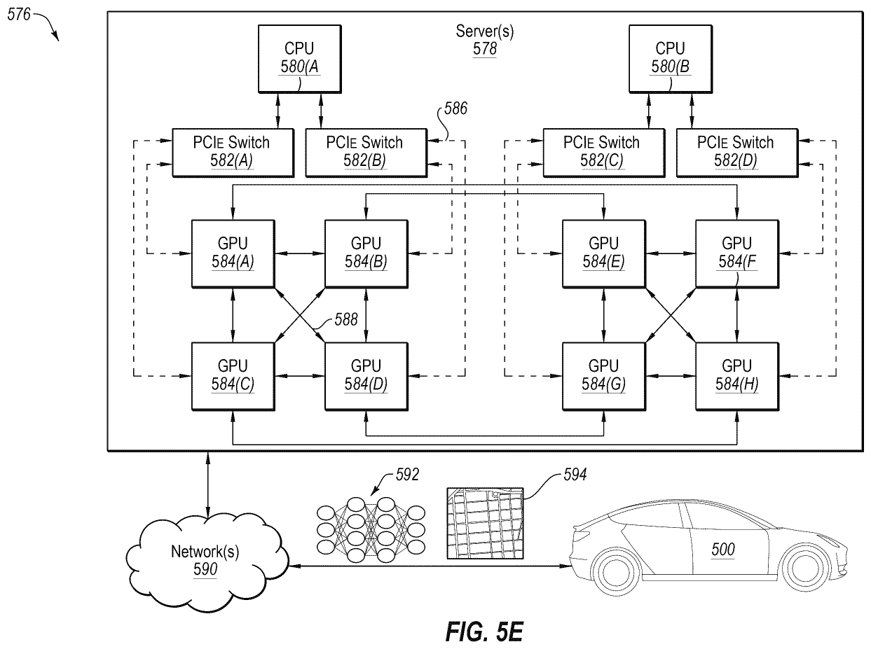

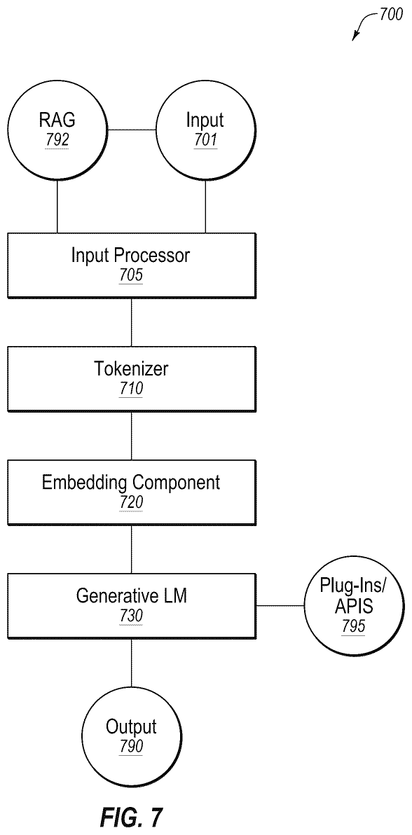

FIG. 2 is a flow diagram illustrating a method 200 of verifying normal shutdown of a remote control system (e.g., the remote control system 110 of FIG. 1), in accordance with one or more embodiments of the present disclosure. One or more operations of the method 200 may be performed by any suitable system, apparatus, or device such as, for example, the main control system 102 of FIG. 1, the autonomous vehicle system(s) described with respect to FIGS. 5A-5D, computing device(s) described with respect to FIG. 6, and/or the data system(s) described with respect to FIG. 7 in the present disclosure.

At block 202, a machine may receive remote operation commands such as the remote control commands 106 of FIG. 1. In some embodiments, the remote control commands may be received from a remote control device (e.g., the remote control device 104). The remote control commands may specify certain remote operations to be performed by the machine. For example, the remote control commands may correspond to remote parking operations to be performed by the machine. In some embodiments, the machine may receive the remote control commands using a wireless communication system, such as the wireless communication system 108 of FIG. 1.

At block 204, the machine, using a main control system (e.g., the main control system 102 of FIG. 1) of the machine, may verify whether a remote control system, such as the remote control system 110 of FIG. 1) was shut down gracefully during a previous attempt to shut down the remote control system (e.g., during the most recent shutdown attempt). For instance, the remote control system may have previously shut down after completing one or more operations based at least on remote operation commands previously received. Subsequently, additional remote operation commands may be received via the wireless communication system to perform one or more additional remote operations. In these and other embodiments, the shutdown of the remote control system after completing the previously remote operations may be verified to determine the current status and ability of the remote control system with respect to the additional remote operation commands. Reference to “graceful shutdowns” in the present disclosure may include shutdowns that follow general shutdown processes such as closing ongoing operations, releasing resources, and saving any necessary data. In instances a graceful shutdown fails, a system (e.g., the remote control system) may be shut down forcefully or shut down without following the normal shutdown sequence or operations. For example, the remote control system may be physically powered off.

In some embodiments, the main control system may be configured to cause general operations of the machine. For example, the main control system may cause the machine to move, drive, park, among others. In these and other embodiments, the remote control system may be configured to deliver the remote control commands to the main control system. For example, the remote control system may receive the remote control commands from the remote control device via the wireless communication system. The remote control system may deliver the remote control commands to the main control system.

At block 206, in response to determining that the remote control system was not shut down gracefully (e.g., the remote control system was shut down forcefully), the remote operations may be disabled, such that the remote control commands are not delivered to the main control system. For example, the system may not be allowed to switch into the second operating mode or the remote operating mode to perform the remote operations. In some embodiments, the forceful shutdown or a failed attempt of graceful shutdown may indicate that the remote control system and/or other parts associated with the wireless communication have issues. For example, the remote control system may have experienced a security breach. In these and other embodiments, the remote control system and the remote operations may be disabled to reduce chances of the issues of the remote control system affecting the main control system.

In some embodiments, the remote operations may remain disabled until the issue with the remote control system is resolved. For example, the remote operations may be disabled until a full reboot of the system, including the remote control system, occurs. In some embodiments, the user of the remote control device that sent the remote control commands may be notified of unavailability of the remote operation. For example, a notification may be sent, via the wireless communication system, that the remote operations are disabled.

At block 208, in response to verifying the graceful shutdown of the remote control system, the main control system may verify that the remote control system is booted. For example, the main control system may verify that the remote control system is in an operational state to relay the remote control commands to the main control system.

In some embodiments, in response to determining that the remote control system is not booted, the main control system may send a boot request to a system manager (e.g., the system manager 112 of FIG. 1). At block 210, the system manager may cause the remote control system to boot.

Modifications, additions, or omissions may be made to the method 200 without departing from the scope of the present disclosure. For example, the operations of method 200 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 3 is a diagram for a method 300 of switching an operating mode of a machine to a first operating mode, in accordance with one or more embodiments of the present disclosure. In particular, the method 300 may illustrate a process of switching to a first operating mode (e.g., the local operating mode) from a second operating mode (e.g., a remote operating mode). One or more operations of the method 300 may be performed by any suitable system, apparatus, or device such as, for example, the main control system 102 of FIG. 1, the autonomous vehicle system(s) described with respect to FIGS. 5A-5D, computing device(s) described with respect to FIG. 6, and/or the data system(s) described with respect to FIG. 7 in the present disclosure.

At block 302, a command to switch the operating mode of the machine to the first operating mode or the local operating mode may be received. In some embodiments, the command may be received from a user or an operator of the machine. For example, the user may physically power on the machine, provide a direct command to switch to the first operating mode, begin performing operations associated with the first operating mode, among others.

At block 304, a remote control system (e.g., the remote control system 110 of FIG. 1) of the machine may be shut down. For example, a main control system (e.g., the main control system 102 of FIG. 1) of the machine may receive a request to shutdown the remote control system. In these and other embodiments, the remote control system may be configured to facilitate the main control system to perform the remote operations in the second operating mode. For example, the remote control system may be configured to facilitate the communication of the remote control commands received from a remote control device to the main control system, such that the main control system may perform the remote operations corresponding to the remote control commands.

In these and other embodiments, shutting down the remote control system for operating in the first operating mode may help reduce chances of unauthorized parties getting access to the main operations (e.g., operations performed in the first operating mode such as driving) of the machine. For instance, unauthorized parties may not access the main control system via the wireless communication channels used with respect to the remote operations.

At block 306, the shutdown of the remote control system may be verified. In particular, in some embodiments, a graceful shutdown of the remote control system may be verified. For example, the main control system may verify that the remote control system was shut down following normal shutdown procedures. In response to successful verification of the graceful shutdown, the machine may switch into the first operating mode. For example, the main control system may be authorized to perform local operations in the first operating mode.

In response to determining that the remote control system has not yet or failed to shut down, at block 310, an occurrence of shutdown timeout may be verified. In these and other embodiments, the shutdown timeout may refer to a predefined period or limit set for a system (e.g., the remote control system, a VM, etc.) to gracefully shut down the processes and close all running applications before being forcibly shut down (e.g., powered off). The verification of the shutdown timeout may refer to verifying that the remote control system gracefully shut down within the predefined period or limit.

In response to verifying that the shutdown timeout has occurred, at block 312, the main control system may query the shutdown gracefulness to a system manager. The shutdown gracefulness may represent a type of shutdown a system (e.g., the remote control system) experienced. For example, the shutdown gracefulness may indicate that the remote control system was shut down gracefully or forcefully. In some embodiments, the shutdown gracefulness may be used in determining whether the machine may switch to the second operating mode to perform remote operations based on a subsequent remote control command. For example, in instances in which the remote control system was shut down forcefully, the second operating mode may be disabled, which is described in further detail, for example, with respect to FIG. 2 of the present disclosure.

In response to verifying that the shutdown timeout has not occurred, at block 314, the main control system may send a shutdown request to a system manager (e.g., the system manager 112 of FIG. 1). The system manager may be configured to monitor different systems and/or processors of the machine and manage lives and operations of the systems.

At block 316, the system manager may be configured to verify certain conditions have been met. The conditions may include conditions or events that may indicate that remote control system is experiencing issues such as a security breach. For example, the certain conditions may include whether the shutdown timeout has occurred. The shutdown timeout may indicate that the remote control system failed to shut down within the predefined time period. Such delay in the shutdown process may indicate that the remote control system is not able to go through the shutdown process. Additionally or alternatively, the certain condition may include receiving a shutdown completion message was while the shutdown is not complete. For example, the remote control system may be compromised to fake the shutdown by generating the shutdown completion message. In some embodiments, other conditions that may indicate presence of an issue may be verified.

At block 318, in instances in which any of the conditions are met, the system manager may forcefully shut down the communication system. For example, in instances in which the shutdown timeout has occurred or a shutdown complete message was received while the remote control system is on, the system manager may forcefully shut down the remote control system to reduce chances of a breached remote control system affecting the main control system or other parts of the machine. A forceful shutdown may refer to the process of forcibly turning off a device when normal or graceful shutdown procedures are not functioning or cannot be completed.

At block 320, in response to verifying that the conditions have not been met, the system manager may continue the graceful shutdown process of the remote control system. In response to completing the shutdown process, the remote control system may return a shutdown complete message to the system manager. In some embodiments, the system manager may verify the shutdown complete message, such as with respect to block 316.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

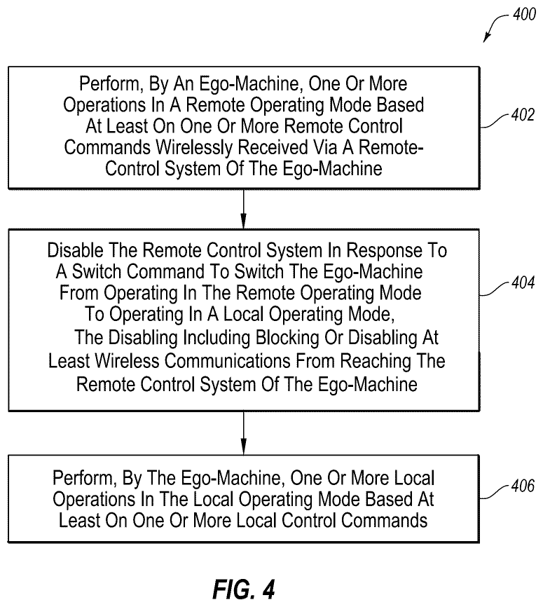

FIG. 4 is a flow diagram illustrating a method 400 of switching a machine between operating modes, in accordance with one or more embodiments of the present disclosure. One or more operations of the method 400 may be performed by any suitable system, apparatus, or device such as, for example, the main control system 102, the remote control system 110, and/or the system manager 112 of FIG. 1, the autonomous vehicle system(s) described with respect to FIGS. 5A-5D, computing device(s) described with respect to FIG. 6, and/or the data system(s) described with respect to FIG. 7 in the present disclosure.

At block 402, one or more operations may be performed by a machine (e.g., an ego-machine). In some embodiments, the one or more operations may be performed, in a remote operating mode, based at least on one or more remote control commands wirelessly received via a wireless communication system of the machine. In some embodiments, the remote control commands received via the wireless communication system may be communicated to a main control system of the machine via a remote control system (e.g., the remote control system 110 of FIG. 1). In some embodiments, the remote operating mode may include a remote parking mode. For instance, the remote operations performed by the machine in the remote operating mode may include remote parking, in which the machine parks or moves to particular location with a user of the machine not physically in the machine or controlling the machine. In some embodiments, performance of the remote operations may be described, for example, with respect to FIG. 1 of the present disclosure.

At block 404, the remote control system of the ego-machine may be disable in response to a switch command to switch the machine from operating in the remote operating mode to operating in a local operating mode. In some embodiments, the disabling may include blocking or disabling at least wireless communications from reaching the remote control system of the ego-machine. In some embodiments, the local operating mode may include a local driving mode. The machine in the local operating mode may be configured to perform local operations considered normal for the machine. For example, in instances the machine is a vehicle, the local operations may include driving. In some embodiments, the disabling of the remote control system may disable or remove the communication channel between the remote control device and the main control system of the machine. In these and other embodiments, disabling of the communication channel may help keep out unauthorized access to the main control system via the communication channel.

In some embodiments, the disabling of the remote control system may include verifying that the remote control system has been disabled based at least on one or more of a predefined time limit associated with a corresponding disablement process or a receipt of a completion message indicating completion of the disablement process. The predefined time limit may define a period of time that the remote control system is expected to finish the normal or graceful shutdown process. A failure to complete the shutdown process within the predefined time limit may indicate possibility of an issue with the remote control system, such as a security breach. In some embodiments, disabling the remote control system may include disabling one or more physical components of the remote control system. For example, in instances in which the remote control system is individually implemented on a certain hardware, the certain hardware may be shut down to disable the remote control system. In some embodiments, other physical components associated with the remote control system, such as the wireless communication system, may be disabled.

In some embodiments, the remote control system and the main control system of the machine may be implemented using respective VMs. For example, the remote control system may be implemented on a remote control VM, and the main control system may be implemented on a main VM. In some embodiments, the remote control VM and the main control VM may be implemented using a same hypervisor or a host system. In other embodiments, the remote control VM and the main control VM may be implemented on separate hypervisors or host systems. In instances in which the remote control system and the main control system are implemented on respective VMs, the disabling of the remote control system may include shutting down the remote control VM.

In some embodiments, in instances the remote control system and the main-control system are implemented using a same processor, the processor pools may be divided into at least a first processor pool and a second processor pool. In these and other embodiments, the remote control system may be operated using the first processor pool, and the main control system may be operated using the second processor pool. Such separation of the processor pools between the remote control system and the main control system may help protect the main control system from any issues with the remote control system.

At block 406, one or more local operations may be performed by the machine in the local operating mode based at least on one or more local control commands. For example, the machine may switch from the remote operating mode to the local operating mode after disabling the remote control system. The main control system of the machine may cause the machine to perform one or more local operations corresponding to the one or more local control commands. In these and other embodiments, the one or more local control commands may include commands received at the machine. For example, the one or more local control commands may include a user turning a steering wheel or other interacting with other control mechanisms to cause the movement of the machine.

Modifications, additions, or omissions may be made to the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

For example, in some embodiments, the method 400 may further include, prior to performing the one or more operations in the remote operating mode by the machine, determining whether the remote control system was disabled in a controlled manner in a most recent prior attempt to disable the remote control system.

For instance, the machine may have performed remote operations based on previous remote control commands received prior to the current remote control commands. Following the completion of the previous remote operations, an attempt to shut down the remote control system is made. Prior to performing the one or more current operations, the previous attempt of shutting down the remote control system may be verified to determine that the remote control system is in status or condition to perform the one or more current operations. For example, in instances in which the remote control system failed to shut down in the controlled manner, the remote control system may have an issue, such as a security breach, that may prevent the performance of the one or more current operations. In response to determining that the remote control system was not disabled in the controlled manner in the most recent prior attempt to disable, the one or more operations may be indicated as not available. For example, the machine may not switch to the remote operating mode to perform the one or more operations corresponding to the one or more remote control commands.

In instances in which the remote control system was disabled in the controlled manner in the most recent prior attempt to disable, the method 400 may further include enabling the remote control system. The machine may switch from operating in the local operating mode to the remote operating mode, and the one or more operations may be performed in the remote operating mode.

### Example Autonomous or Semi-Autonomous Machine

FIG. 5A is an example of sensor locations having corresponding fields of view or sensory fields for an autonomous or semi-autonomous vehicle 500a, an autonomous mobile robot (AMR) 500b, and a humanoid robot 500c, in accordance with some embodiments of the present disclosure. Although three types of machines 500 are illustrated, this is not intended to be limiting, and the machine(s) 500 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 500a, AMR 500b, humanoid robot 500c, and/or other machine types may be referred to herein collectively as machine 500, in some instances.

With respect to vehicles 500A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 500 may be capable of functionality in accordance with one or more of Level 3-Level 5 of the autonomous driving levels. The machine 500 may be capable of functionality in accordance with one or more of Level 1-Level 5 of the autonomous driving levels. For example, the machine 500 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 500 or other machine, such as being fully autonomous, being highly autonomous, being conditionally autonomous, being partially autonomous, providing assistive autonomy, being semi-autonomous, being primarily autonomous, or other designation.

With respect to FIG. 5A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 568D, a 180 degree field of view of a wide-view camera 570, a 360 degree sensory field of a LiDAR sensor 564, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 500a, AMR 500b, and/or humanoid robot 500c, etc. For example, with respect to the vehicle 500a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 500b and/or humanoid robot 500c, the shape, size, purpose, implementation, model, etc. may dictate the number and types of sensors used.

As illustrated in FIG. 1A, the autonomous or semi-autonomous vehicle 500A, the AMR 500B, and the humanoid robot 500C may include different sensor types, number, and locations. For a non-limiting example, the vehicle 500A may include twelve cameras 564, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 564 may use, in embodiments, a gigabit multimedia serial link (GMSL) interface—such as GMSL2—as input/output (I/O).

In some embodiments, although not illustrated in FIG. 5A, the vehicle 500A may include an in-cabin occupant and/or driver monitoring system, that may include various different sensors. For example, the in-cabin sensors may include various cameras 568, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 568, the internal camera(s) 568 may, in embodiments, use a GMSL (such as GMSL2) interface for I/O.

As another non-limiting example, the vehicle 500A may further include nine RADAR sensors 560. For example, the vehicle 500A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 560 may use, in embodiments, an Ethernet interface as I/O.

The vehicle(s) 500A may further include, as a non-limiting example, twelve ultrasonic sensors 562. As illustrated in FIG. 5A, the ultrasonic sensors may be positioned along the front and rear bumpers of the vehicle 500A, and along the side of the vehicle 500A, and may be used to detect objects (static and dynamic) in close proximity to the vehicle 500A. In some embodiments, the ultrasonic sensor(s) 562 may use a DS13 interface as I/O.

The vehicle(s) 500A may further include, as a non-limiting example, a LiDAR sensor 564, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 564 may include a 360 degree horizontal FOV or sensory field (such as in a spinning LiDAR sensor) and a 90 degree vertical FOV or sensory field. In some embodiment, the LiDAR sensor(s) 564 may use an Ethernet interface as I/O.

The autonomous mobile robot (AMR) 500B may include, as a non-limiting example, three LiDAR sensors 564. For example, the top-most illustrated LiDAR sensor 564 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 500B may further include, as a non-limiting embodiment, eight cameras 568, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 500B may further include a charging port, charging port contacts, a status indicator light, one or more (e.g., four) RGB LEDs, one or more IMU sensors 566, a magnetometer, and a barometer. The AMR 500B is capable of high-precision time synchronization between sensors using hardware time stamping, and PTP over Ethernet with less than 10 microseconds for sensor acquisition time. The AMR 500B provides simultaneous camera capture across all cameras 568 within 100 microseconds from a single hardware trigger, in embodiments, and can write to disk at 4GB/second for sensor capture to bag writing (e.g., writing to ROSbags for the robot operation system (ROS)). As such, the AMR 500B is capable of running the ROS (such as NVIDIA's Isaac ROS), can be teleoperated (as described herein), can map an environment, and can navigate within an environment using visual cameras 568, LiDARs 564, and/or other sensor types or modalities.

The humanoid robot 500C may include, as a non-limiting example, one LiDAR sensor 564. For example, the LiDAR sensor 564 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 500C may further include, as a non-limiting embodiment, four cameras 568, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 500C may further include, as a non-limiting embodiment, four ultrasonic sensors 562, such as a left arm ultrasonic sensor, a right arm ultrasonic sensor, a left leg ultrasonic sensor, and right leg ultrasonic sensor.

The humanoid robot 500C may further include any number of actuators—such as to allow control and maneuverability of joints. For example, the humanoid robot 500C may include actuators that allow for various degrees of freedom (DoF) depending on the design. In a non-limiting embodiment, the humanoid robot 500C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 500C may include position and orientation sensors, such as encoders, gyroscopes, and the like, to determine the position of the robot 500C in space, allowing for location determination and movement tracking. The humanoid robot 500C may include force and pressure sensors, in embodiments, to detect environment interactions, allowing the robot 500C to grasp objects with the right force and to avoid obstacles along the way. The perception sensors (e.g., cameras, LiDARs, RADARs, ultrasonic, SONAR, etc.) may be used along with tactile sensors to allow the robot 500C to perceive objects, shapes, and textures, and to understand when touch is initiated and stopped (along with force sensors that regulate the force used during touch). As a non-limiting example, the humanoid robot 500C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 500C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 500C may use onboard sensors, microphones, and speakers to understanding speech, audio and visual cues, etc., while also being able to communicate back to the environment.

With reference to cameras 568 of the machine(s) 500, the camera types for the cameras 568 may include, but are not limited to, digital cameras that may be adapted for use with the components and/or systems of the machine 500. For a vehicle 500a implementation, the camera(s) 568 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 568B that may be used to perceive objects coming into view from the periphery (e.g., pedestrians, warehouse vehicles, other robots, crossing traffic, or bicycles). In addition, any number of long-range camera(s) 568E (e.g., a long-view stereo camera pair) may be used for depth-based object detection, especially for objects for which a neural network has not yet been trained. The long-range camera(s) 568E may also be used for object detection and classification, as well as basic object tracking.

Any number of stereo cameras 568A may also be included in a front-facing and/or other (e.g., rear-facing) configuration. In at least one embodiment, one or more of stereo camera(s) 568A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 500 environment, including a distance estimate for points in the image (e.g., a disparity or depth image). An alternative stereo camera(s) 568A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 500 (e.g., side-view cameras) may be used, for example, for surround view, providing information used to create and update the occupancy grid, as well as to generate side impact collision warnings and/or to indicate to an AMR 500B or humanoid robot 500C, for example, that there are objects, features, and/or persons present to the side. For example, surround camera(s) 568D may be positioned on the machine 500. The surround camera(s) 568D may include wide-view camera(s) 568B, fisheye camera(s), 360 degree camera(s), and/or the like. For example, four fisheye cameras may be positioned on the machine's 500 front, rear, and sides. In an alternative arrangement, the machine 500 may use three surround camera(s) 568D (e.g., left, right, and rear), and may leverage one or more other camera(s) (e.g., a forward-facing camera) as a fourth surround view camera.

Cameras 568 with a field of view that include portions of the environment to the rear of the machine 500 (e.g., rear-view cameras) may be used for gaining an understanding of objects, features, persons, and/or other information to the rear of the machine 500, such as for park assistance, surround view, rear collision warnings, planning, control, and navigation determinations, and/or creating and updating an occupancy grid, BEV image representing the environment, height map, etc. A wide variety of cameras 568 may be used including, but not limited to, cameras 568 that are also suitable as a front-facing camera(s) (e.g., long-range and/or mid-range camera(s) 568E, stereo camera(s) 568A), infrared camera(s) 568C, etc.), rear-facing camera(s), side-facing camera(s), downward facing camera(s), upward facing camera(s), and/or the like, as described herein.

Similarly, for LiDAR sensors 564, RADAR sensors 560, ultrasonic sensors 562, and/or other sensor modalities or types, the location and placement of the sensors, and their corresponding fields of view or sensory fields may be determined based on the use case, implementation, or design of the particular machine 500.

For example, the machine(s) 500 include RADAR sensor(s) 560 that may be used by the machine 500 for long-range object detection, even in darkness and/or severe weather conditions. RADAR functional safety levels may be ASIL B, in embodiments. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 500 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 560 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 500 (e.g., vehicle, robot, etc.). As such, short-range RADAR systems may be used in an ADAS system for blind spot detection and/or lane change assist.

The machine 500 may further include ultrasonic sensor(s) 562. The ultrasonic sensor(s) 562, which may be positioned at the front, back, and/or the sides of the machine 500, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 500. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B, as an example.

The machine 500 may include LiDAR sensor(s) 564. The LiDAR sensor(s) 564 may be used for object and feature detection, pedestrian and other robot detection, emergency braking, collision avoidance, simultaneous localization and mapping (SLAM), free-space detection, and/or other functions. The LiDAR sensor(s) 564 may be functional safety level ASIL B, in embodiments. In some examples, the machine 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 500 m, with an accuracy of 2 cm-3 cm, and with support for a 500 Mbps Ethernet connection, for example. In some examples, one or more non-protruding LiDAR sensors 564 may be used. In such examples, the LiDAR sensor(s) 564 may be implemented as a small device that may be embedded into the front, rear, sides, top, and/or corners of the machine 500. The LiDAR sensor(s) 564, in such examples, may provide up to a 120-degree horizontal and 35-degree vertical field-of-view, with a 200 m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

FIG. 5B is an illustration of sensor and component locations of an example autonomous or semi-autonomous vehicle 500A (alternatively referred to herein as “vehicle 500,” “ego-vehicle 500,” “ego-machine 500,” or “machine 500,”), in accordance with some embodiments of the present disclosure. Although the vehicle 500A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

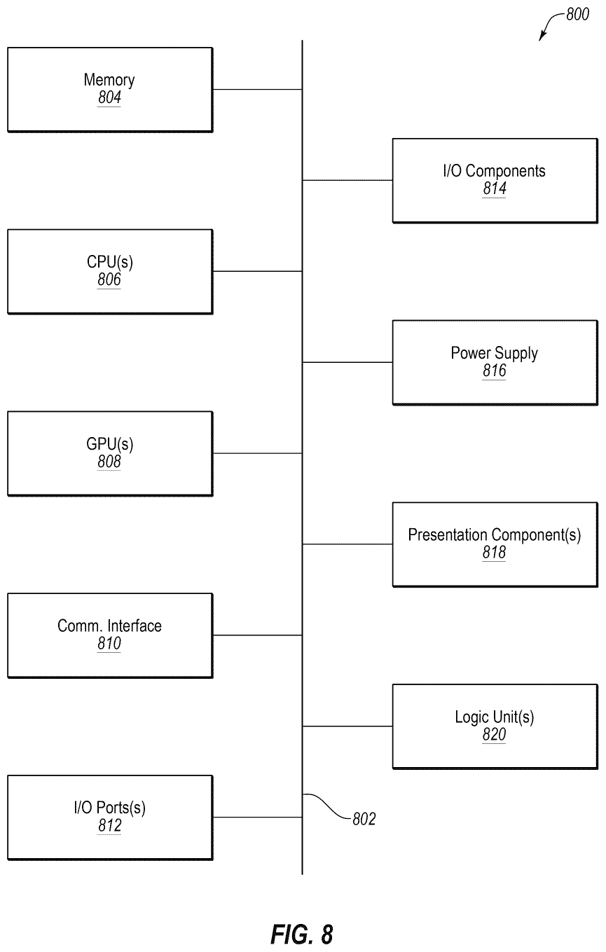

FIG. 5C is a block diagram of an example system architecture for a machine 500, such as autonomous or semi-autonomous vehicle 500A, autonomous mobile robot (AMR) 500B, humanoid robot 500C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 500 of FIGS. 5A-5E, example computing ecosystem 600 of FIG. 6, example generative language model system 700 of FIG. 7, and/or example computing device 800 of FIG. 8.

Each of the components, features, and systems of the machine 500 in FIG. 5C are illustrated as being connected via bus 502 (alternatively referred to as a “machine communications network 502,” or just “communications network 502”). The bus 502 may include a Controller Area Network (CAN) data interface (alternatively referred to herein as a “CAN bus”). A CAN may be a network inside the machine 500 used to aid in control of various features and functionality of the machine 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 502 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the machine 500, and two or more busses 502 may communicate with the same components. In some examples, each SoC 504, each controller 536, and/or each computer or compute engine within the machine 500 may have access to the same input data (e.g., inputs from sensors of the machine 500), and may be connected to a common bus, such as a CAN bus.

The machine 500 may include components such as a chassis, a vehicle body, wheels (e.g., 2, 4, 6, 8, 18, etc.), tires, axles, batteries, side-view mirrors, and/or other components of a vehicle or machine. The machine 500 may include a propulsion system 550, such as an internal combustion engine, hybrid electric power plant, an all-electric engine, a hydrogen-fueled engine, and/or another propulsion system type. The propulsion system 550 may be connected to a drive train of the machine 500, which may include a transmission, to enable the propulsion of the machine 500. The propulsion system 550 may be controlled in response to receiving signals from the throttle/accelerator 552.

A steering system 554, which may include a steering wheel and/or other steering device (e.g., remote steering and/or local steering), may be used to steer the machine 500 (e.g., along a desired path or route) when the propulsion system 550 is operating (e.g., when the vehicle is in motion). The steering system 554 may receive signals from a steering actuator 556. In some embodiments, a steering wheel or other steering mechanism may not be included, such as for a machine 500 capable of full automation (e.g., Level 5) functionality.

The brake sensor system 546 may be used to operate the vehicle brakes in response to receiving signals from the brake actuators 548 and/or brake sensors.

The machine 500 may include one or more controller(s) 536, such as those described herein with respect to FIG. 5A. The controller(s) 536 may be used for a variety of functions, and may be coupled to any of the various other components and systems of the machine 500. For example, the controllers 536 may be used for control of the machine 500, artificial intelligence executing on the machine 500, infotainment for the machine 500, and/or the like. For example, one controller 536 may be used for some or all of the functionality, or different controllers 536 may be used for different functionalities—e.g., to ensure availability and a safety separation between various controllers for different tasks. For example, the controller(s) 536 may use plans computed by the system—e.g., paths or trajectories for vehicles 500A or AMRs 500B, or movements, components trajectories, movement locations or displacements, etc. for joints or components (e.g., of manipulators, end effectors, limbs, hands, fingers, legs, feet, etc.), of a humanoid robot 500C—to control the machine(s) 500 in the environment. In some instances, the controller(s) 536 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 500C, for example, the controller(s) 536 may act as the brain, responsible for analyzing sensor data, making decisions, and sending commands to the actuators. The controller(s) 536 may include a low-level controller that handles basic motor control, ensuring accurate and precise movements of individual joints and actuators. The controller(s) 536 may include a high-level controller to coordinate multiple actuators and sensors, planning complex motions and adapting to changing environments.

The controller(s) 536 may include an artificial intelligence controller, in embodiments, that may use AI algorithms (e.g., DNNs, MLMs, etc.) to learn, make decisions, and autonomously perform tasks for the machine 500. In some embodiments, the controller(s) 536 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 536 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 536, which may include one or more systems on chip (SoCs) 504 (FIGS. 5C and 5D), CPUs, GPU(s), accelerator(s), etc., may provide signals (e.g., representative of commands or messages) to one or more components and/or systems of the machine 500. Although the controller(s) 536 is listed separately from the SoC(s) 504, this is not intended to be limiting, and in some embodiments one or more components of the SoC(s) 504 may perform the operations of the controller(s) 536. For example, the controller(s) may send signals to operate the machine brakes via one or more brake actuators 548, to operate the steering system 554 via one or more steering actuators 556, to operate the propulsion system 550 via one or more throttle/accelerators 552, etc. The controller(s) 536 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 500. The controller(s) 536 may include a first controller 536 for autonomous control and navigation functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 536 may handle two or more of the above functionalities, two or more controllers 536 may handle a single functionality, and/or any combination thereof.

The controller(s) 536 may provide the signals for controlling one or more components and/or systems of the machine 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, camera(s) 568 (e.g., stereo camera(s) 568A, wide-view camera(s) 568B (e.g., fisheye cameras), infrared camera(s) 568C, surround camera(s) 568D (e.g., 360 degree cameras), long-range and/or mid-range camera(s) 568E, and/or other camera types), speed sensor(s) 544 (e.g., for measuring the speed of the machine 500), vibration sensor(s) 542, steering sensor(s) 540, brake sensor(s) (e.g., as part of the brake sensor system 546), actuators, and/or other sensor types.

One or more of the controller(s) 536 may receive inputs (e.g., represented by input data) from an instrument cluster 532 of the machine 500 and provide outputs (e.g., represented by output data, display data, etc.) via a human-machine interface (HMI) display 534 (e.g., screen, heads-up display, mirror display, facial display, robotic display, etc.), an audible annunciator, a loudspeaker, a speaker, and/or via other components of the machine 500. The outputs may include information such as machine velocity, speed, time, map data corresponding to a map(s) 522 of FIG. 5C (e.g., from a navigation map, a Standard Definition (SD) map, a High Definition (“HD”) map, etc.), location data (e.g., the machine's 500 location, such as on a map 522), direction, location of other vehicles (e.g., an occupancy map, height map, bird's eye view (BEV) image, grid, etc.), information about objects and status of objects as perceived by the system, system status information, etc. For example, the HMI display(s) 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 500 may include one or more systems on a chip (SoCs) 504 (described in more detail in FIG. 5D). The SoC(s) 504 may include CPU(s) 506, GPU(s) 508, processor(s) 510, cache(s) 512, accelerator(s) 514, data store(s) 516, and/or other components and features. The SoC(s) 504 may be used to process and provide data for various operations, such as navigation, planning, reasoning, inference, perception, control, and/or actuation operations of the machine 500 in a variety of platforms and systems. For example, the SoC(s) 504 may process live perception data (e.g., from camera, LiDAR, RADAR, ultrasonic, etc.) in addition to map data corresponding to one or more maps 522 (e.g., HD map, SD map, navigational map, occupancy map, etc.) in order to make or aid in performing various operations of the machine 500. Where a map and/or AI is used, map and/or AI (e.g., model parameter updates, fine-tuning, etc.) refreshes and/or updates via a network interface 524 from one or more servers (e.g., server(s) 578 of FIG. 5E)—such as one or more servers of a cloud-based data center.

Although an SoC(s) 504 is illustrated throughout FIGS. 5A-5E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 500, use of the machine 500, model of the machine 500, and required capabilities of the machine 500, one or more SoCs 504 and/or alternative architectures and/or components may be used to satisfy the particular implementation.

The machine 500 may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The machine 500 may include a GPU(s) 520 (e.g., discrete GPU(s), or dGPU(s)), that may be coupled to the SoC(s) 504 via a high-speed interconnect (e.g., NVIDIA's NVLink). The GPU(s) 520 may provide additional artificial intelligence functionality, such as by executing redundant and/or different neural networks, and may be used to train and/or update neural networks based on input (e.g., sensor data) from sensors of the machine 500.

The machine 500 may further include the network interface 524 which may include one or more wireless antennas 526 and/or modems (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 500 information about vehicles in proximity to the machine 500 (e.g., vehicles in front of, on the side of, and/or behind the machine 500). This functionality may be part of a cooperative adaptive cruise control functionality of the machine 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The machine 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The machine 500 may further include IMU sensor(s) 566. The IMU sensor(s) 566 may be located at a center of the rear axle of the machine 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the machine 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include one or more microphone 596 placed in and/or around the machine 500. The microphone(s) 596 may be used for emergency vehicle detection and identification, among other things.

The machine 500 may further include vibration sensor(s) 542. The vibration sensor(s) 542 may measure vibrations of components of the machine, such as the arms or legs of a humanoid robot 500C, or the axle(s) of a vehicle 500A or AMR 500B. For example, changes in vibrations may indicate a change in road, walking, or traversable surfaces. In another example, when two or more vibration sensors 542 are used, the differences between the vibrations may be used to determine friction or slippage of the surface (e.g., when the difference in vibration is between a power-driven axle and a freely rotating axle).

The machine 500 may include an ADAS system 538—such as when the machine 500 is a vehicle 500A. The ADAS system 538 may include a dedicated SoC(s), in some examples. The ADAS system 538 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 500 may further include the infotainment SoC 530 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the machine 500. In some examples, the infotainment SoC 530 may be coupled to a supervisory MCU such that the GPU of the infotainment system may perform some self-driving functions in the event that the primary controller(s) 536 (e.g., the primary and/or backup computers of the machine 500) fail. In such an example, the infotainment SoC 530 may put the machine 500 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models-such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 500—whether a vehicle 500A, AMR 500B, humanoid robot 500C, and/or other type of machine—may include a locally stored language model(s) and/or communicate to a remotely hosted language model (e.g., via one or more APIs) to provide more detailed and in-depth communication features to the users of the machine(s) 500.

In some examples, an infotainment SoC 530, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 500.

The machine 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a block diagram of an example architecture of a computing system (a subset of the system described with respect to FIG. 5C), in accordance with at least some embodiments of the present disclosure. Although illustrated as an SoC(s) 504, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 504 may be an end-to-end platform with a flexible architecture that spans automation levels 2-5, or the SoC(s) 504 may be specifically designed for a specific automation level (e.g., a first SoC 504 for level 2 to level 2++, a second SoC 504 for level 3, a third SoC 504 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 2-5 autonomous vehicles as well as for safe planning, navigation, and control of AMRs 500B, humanoid robots 500C, and/or other robot or machine types.

In some embodiments, such as where the SoC(s) 504 include a GPU 508 with 2000 or more cores (e.g., 2048 cores), 60 or more tensor cores (e.g., 64 tensor cores), and a GPU max frequency of over 1 GHz (e.g., 1.3 GHz), a CPU 506 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 509 (e.g., 2 DLAs/XNNs/NNAs/NPUs 509), and a vision accelerator—such as a programmable vision accelerator (PVA) 507, a single SoC 504) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 504 include a GPU 508 with 1700 or more cores (e.g., 1792 cores), 50 or more tensor cores (e.g., 56 tensor cores), and a GPU max frequency of over 900 MHz (e.g., 930 MHz), a CPU 506 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 509 (e.g., 2 DLAs/XNNs/NNAs/NPUs 509), and a vision accelerator—such as a programmable vision accelerator (PVA) 507, a single SoC 504) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 504 include a GPU 508 with 1000 or more cores (e.g., 1024 cores), 28 or more tensor cores (e.g., 32 tensor cores), and a GPU max frequency of over 900 MHz (e.g., 1173 MHz), a CPU 506 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 509 (e.g., 1 DLA/XNN/NNA/NPU 509), and a vision accelerator—such as a programmable vision accelerator (PVA) 507, a single SoC 504) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 504 include a GPU 508 with 1000 or more cores (e.g., 1024 cores), 28 or more tensor cores (e.g., 32 tensor cores), and a GPU max frequency of over 900 MHz (e.g., 1020 MHz), a CPU 506 including 6 or more cores (e.g., 6 cores), with 64 bits, 1.5 MB L2 and 4 MB L3 cache memory, and a max frequency of 1.5 or more GHz (e.g., 1.7 GHz), a single SoC 504) may be capable of 67 tera operations per second (TOPS) of AI performance. For example, NVIDIA's Jetson Orin Nano 8 GB SoC satisfies these criteria, and achieves this performance.

The SoC(s) 504 may include one or more CPUs 506. The CPU(s) 506 may include a CPU cluster or CPU complex (alternatively referred to herein as a “CCPLEX”), in embodiments. The CPU(s) 506 may include multiple cores and/or (e.g., L2, L3) caches. For example, in some embodiments, the CPU(s) 506 may include twelve cores in a coherent multi-processor configuration. In some embodiments, the CPU(s) 506 may include four dual-core clusters where each cluster has a dedicated L2 cache (e.g., a 3 MB L2 cache). The CPU(s) 506 (e.g., the CCPLEX) may be configured to support simultaneous cluster operation enabling any combination of the clusters of the CPU(s) 506 to be active at any given time.

The SoC(s) 504 may include any type and number of GPUs 508. For example, an integrated GPU(s) (alternatively referred to herein as an “iGPU(s)”) may be used in some embodiments. The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive, robotics, and/or other embedded use cases. For example, the GPU(s) 508 may be fabricated on a Fin field-effect transistor (FinFET). However, this is not intended to be limiting and the GPU(s) 508 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

The SoC(s) 504 may include any number of cache(s) 512, including those described herein. For example, the cache(s) 512 may include L0 caches, L1 caches, L2 caches, L3 caches (e.g., that are available to both the CPU(s) 506 and the GPU(s) 508 (e.g., that is connected both the CPU(s) 506 and the GPU(s) 508)), etc. The cache(s) 512 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 504 may include one or more arithmetic logic units (ALUs) 565 which may be leveraged in performing processing with respect to any of the variety of tasks or operations of the machine 500—such as computer vision, machine learning or deep learning processing, world model management, etc. In addition, the SoC(s) 504 may include a floating point unit(s) (FPU(s)) 567—or other math coprocessor or numeric coprocessor types—for performing mathematical operations within the system. For example, the SoC(s) 104 may include one or more FPUs 567 integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory 515 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 514 (e.g., the hardware acceleration cluster) may include a deep learning accelerator(s) (DLA) 509 (alternatively referred to herein as “a deep learning accelerator cluster (XNN) 509,” “neural network accelerator (NNA) 509,” or “neural processing unit (NPU) 509”). The DLA(s) 509 may include one or more Tensor processing units (TPUs) 541 that may be configured to provide an additional, e.g., ten trillion operations per second for deep learning applications and inferencing. The TPUs 541 may be accelerators configured to, and optimized for, performing image processing functions (e.g., for CNNs, RCNNs, DNNs, etc.). The DLA(s) 509 may further be optimized for a specific set of neural network types and floating point operations, as well as inferencing. The design of the DLA(s) may provide more performance per millimeter than a general-purpose GPU, and vastly exceeds the performance of a CPU. The TPU(s) 541 may perform several functions, including a single-instance convolution function, supporting, for example, INT8, INT16, and FP16 data types for both features and weights, as well as post-processor functions. Although the TPU(s) 541 are described as being included as part of the DLA(s) 509, this is not intended to be limiting, and the TPU(s) 541 may be included in additional or alternative accelerator(s) 514 and/or other components, and/or may be included as a discrete processing component(s).

The DLA(s) 509 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 509 may perform any function of the GPU(s) 508, and by using an inference accelerator, for example, a designer may target either the DLA(s) 509 or the GPU(s) 508 for any function. For example, the designer may focus processing of DNNs and floating point operations on the DLA(s) 509 and leave other functions to the GPU(s) 508 and/or other accelerator(s) 514. The DLA(s) 509 may be used to run any type of network to enhance control and safety, including for example, a neural network that outputs a measure of confidence for each object detection.

The accelerator(s) 514 (e.g., the hardware acceleration cluster) may include a programmable vision accelerator(s) (PVA) 507, which may alternatively be referred to herein as a computer vision accelerator or generally a vision accelerator. The PVA(s) 507 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 507 may provide a balance between performance and flexibility. For example, each PVA(s) 507 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 507 may be optimized for the tasks of image processing and computer vision algorithm acceleration. For example, the PVA(s) 507 provides excellent performance with extremely low power consumption, and can be used asynchronously and concurrently with the CPU(s) 506, GPU(s) 508, and/or other accelerators in the system (e.g., vehicle, robot, etc.) as part of a heterogeneous compute pipeline.

The PVA(s) 507 may include one or more (e.g., two) vector processing subsystems (VPS), where each VPS may include one or more vector processing unit (VPU) cores, one or more decoupled lookup units (DLUTs), one or more shared or vector memories (VMEMs), and one or more instruction caches (I-caches). The VPU core(s) may be the main processing unit, and may include a vector SIMD VLIW DSP 543 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 506 (e.g., ARM Cortex-R5 processor), facilitating data exchange with the CPU(s) 506 and other system-level components. The VPU I-cache may supply instruction data to the VPU(s) when requested, may request missing instruction data from system memory, and/or may maintain temporary instruction storage for the VPU. For each VPU task, the CPU(s) 506 may configures the DMA system, optionally prefetch the VPU program into VPU I-cache, and/or kick off each VPU-DMA pair to process a task. The PVA(s) 507 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 507 to access the system memory independently of the CPU(s) 506. The DMA may support any number of features used to provide optimization to the PVA(s) 507 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 507 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 507, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 507 may be configured to employ data parallelism. For example, in some embodiments, the plurality of vector processors included in a single PVA(s) 507 may execute the same computer vision algorithm, but on different regions of an image. In other examples, the vector processors included in a particular PVA(s) 507 may simultaneously execute different computer vision algorithms, on the same image, or even execute different algorithms on sequential images or portions of an image. Among other things, any number of PVAs 507 may be included in the hardware acceleration cluster and any number of vector processors may be included in each of the PVAs. In addition, the PVA(s) 507 may include additional error correcting code (ECC) memory, to enhance overall system safety.

The accelerator(s) 514 (e.g., the hardware accelerator cluster) have a wide array of uses for autonomous and semi-autonomous machine control. The PVA(s) 507 may be a programmable vision accelerator that may be used for key processing stages in perception, robotics understanding and reasoning, ADAS, semi-autonomous, and autonomous vehicles, etc. The PVA's 507 capabilities are a good match for algorithmic domains needing predictable processing, at low power and low latency. In other words, the PVA(s) 507 performs well on semi-dense or dense regular computation, even on small data sets, which need predictable run-times with low latency and low power. Thus, in the context of platforms for autonomous vehicles and robotics, the PVAs 507 are designed to run classic computer vision algorithms, as they are efficient at object detection and operating on integer math.

For example, according to one embodiment of the technology, the PVA 507 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 507 may perform computer stereo vision function on inputs from two monocular cameras.

In some examples, the PVA(s) 507 may be used to perform dense optical flow. According to process raw RADAR data (e.g., using a 4D Fast Fourier Transform) to provide Processed RADAR. In other examples, the PVA(s) 507 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 507, this is not intended to be limiting. In some embodiments, these components may be included in alternative or additional processing components and/or accelerator(s) 514, and/or may be included as discrete components of the SoC(s) 504 and/or other computing system architecture(s).

In some examples, the SoC(s) 504 may include a real-time ray-tracing hardware accelerator (RTA) 551 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 500 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 551 and/or a ray-tracing optimized GPU 506—such as NVIDIA's RTX GPU.

The accelerator(s) 514 (e.g., in the hardware acceleration cluster) may include one or more optical flow accelerators (OFAs) 511. For example, the OFA(s) 511 may be used for computing optical flow and stereo disparity between frames of sensor data (e.g., images). Optical flow may be accelerated on the OFA(s) 511 for uses such as object detection and tracking, and/or for stereo depth estimation where used for computing stereo disparity between stereo image frames (e.g., two or more frames captured using two or more image sensors with at least partially overlapping fields of view).

The SoC(s) 504 may include one or more camera serial interfaces (CSIs) 523. For example, the CSI(s) 523 may include a mobile industry processor interface (MIPI) camera serial interface (CSI) for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role. For example, the CSI 523 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 514 (e.g., the hardware acceleration cluster) may include a computer vision network on-chip (CVNOC) 563 and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by the PVA 507, OFA 511, DLA 509, and/or other accelerator(s) 514. Each pair of memory blocks may include an advanced peripheral bus (APB) interface, configuration circuitry, a controller, and a multiplexer. Any type of memory 515 may be used. The PVA 507, OFA 511, DLA 509, and/or other accelerator(s) 514 may access the memory via a backbone that provides the accelerator(s) 514 with high-speed access to memory. The backbone may include a computer vision network on-chip that interconnects the accelerator(s) 514 to the memory (e.g., using the APB).

The CVNOC 563 may include an interface that determines, before transmission of any control signal/address/data, that the accelerator(s) 514 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 504 may include data store(s) 516 and/or memory 515. The data store(s) 516 may be on-chip memory 515 of the SoC(s) 504, which may store neural networks and/or other algorithms to be executed on the CPU(s) 506, the GPU(s) 508, and/or one or more of the accelerator(s) 514. In some examples, the data store(s) 516 may be large enough in capacity to store multiple instances of neural networks for redundancy and safety. The data store(s) 512 may comprise L2 and/or L3 cache(s) 512, for example. The memory(ies) 515 may include SRAM, LPDDR5, and/or other memory types. For example, the memory(ies) 515 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 516 may include reference to the memory associated with the PVA 507, OFA 511, DLA 509, and/or other accelerator(s) 514, as described herein.

The data store(s) 116 may include various storage types, such as eMMC, NVMe, etc. For example, the SoC(s) 504 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 516 and/or other storage may be accessed via, e.g., NVMe, using PCI Express (PCIe), RDMA, TCP, and/or other protocols.

The SoC(s) 504 may include one or more processor(s) 510 (e.g., embedded processors). The processor(s) 510 may include a boot and power management processor (BPMP) 553, that may be a dedicated processor and subsystem to handle boot power and management functions and related security enforcement. The BPMP 553 may be a part of the SoC(s) 504 boot sequence and may provide runtime power management services. The BPMP 553 may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, accelerator(s) 514, and/or other components. If temperatures are determined to exceed a threshold, BPMP 553 may enter a temperature fault routine and put the SoC(s) 504 into a lower power state and/or put the machine 500 into a chauffeur to safe stop mode (e.g., bring the machine 500 to a safe stop).

The processor(s) 510 may further include a set of embedded processors that may serve as an audio processing engine (APE) 555. The APE 555 may be an audio subsystem that enables full hardware support for multi-channel audio over multiple interfaces, and a broad and flexible range of audio I/O interfaces. In some examples, the APE 555 is a dedicated processor core with a digital signal processor with dedicated RAM.

The processor(s) 510 may further include an always on processor engine (AOPE) 557 that may provide necessary hardware features to support low power sensor management and wake use cases. The AOPE 557 may include a processor core, a tightly coupled RAM, supporting peripherals (e.g., timers and interrupt controllers), various I/O controller peripherals, and routing logic.

The processor(s) 510 may further include a safety processor(s) 513 (alternatively referred to as “safety island 513”), which may include a safety cluster engine that includes a dedicated processor or processor subsystem to handle safety management for automotive, robotics, and/or other applications. The safety processor(s) 513—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 513 may include a discrete processor(s), such that fault of other system components may not impact the performance and availability of the safety processor 513.

The processor(s) 510 may further include a real-time or near real-time sensor engine (SE) 559 that may include a dedicated processor subsystem for handling real-time or near real-time camera, LiDAR, RADAR, and/or other sensor modality management.

The processor(s) 510 may further include one or more image signal processors (ISPs) 527, which may include a high-dynamic range signal processor and/or a hardware engine that is part of one or more sensor processing pipelines.

The processor(s) 510 may include a video image compositor (VIC) 561 that may be a processing block (e.g., implemented on a microprocessor) that implements video post-processing functions needed by a video playback application to produce the final image for the player window. The VIC 561 may perform lens distortion correction on wide-view camera(s) 568B, surround camera(s) 568D, in-cabin monitoring camera sensors, and/or other camera sensors with distorted fields of view.

A VIC 561 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 561 may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a broad range of peripheral interfaces for input/output (I/O) 525, such as to enable communication with peripherals, audio codecs, power management, and/or other devices. The SoC(s) 504 may be used to process data from cameras (e.g., connected over Gigabit Multimedia Serial Link and/or Ethernet), sensors (e.g., LiDAR sensor(s) 564, RADAR sensor(s) 560, etc. that may be connected over Ethernet), data from bus 502 (e.g., speed of machine 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks. In some embodiments, the SoC(s) 504 I/O 525 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 525 elements, components, or features.

The SoC(s) 504 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 504 may include an RJ45 connector with up to 10 GbE, a 1 GbE connector, and/or other networking connector types.

The SoC(s) 104 may include one or more digital signal processors (DSPs) 543. For example, the DSP(s) 543 may include a dedicated or specialized microprocessor chip optimized for digital signal processing-such as in audio signal processing, telecommunications, digital image processing, RADAR, SONAR, LiDAR, and/or other sensor processing, speech recognition, and/or other applications.

The SoC(s) 504 may include one or more video encoders 519 and/or one or more video decoders 521. For example, the video encoder(s) 519 may include a hardware-based (e.g., as part of the GPU(s) 508) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 521 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 521 may be hardware-based (e.g., as part of the GPU(s) 508).

The SoC(s) 504 may include one or more general compute acceleration clusters (GCAC(s)) 529. For example, the GCAC(s) 529 may include various processor types that may be used to accelerate compute, such as one or more vector microcode processors (VMPs) 533, one or more multi-threaded processing clusters (MPCs) 531, one or more programmable macro arrays (PMA(s)) 535, and/or one or more other processor types. For example, the GCAC(s) 529 may include a PMA 535, two VMPs 533, and 2 MPCs 531.

The SoC(s) 504 may include one or more vector microcode processors (VMPs) 533. The VMP(s) 533, in embodiments, may include a wide vector (very long instruction word (VLIW) and single instruction multiple data (SIMD)) machine with performing various operations, such as short integral type operations common in computer vision and deep learning algorithms.

The SoC(s) 504 may include one or more multi-threaded processing clusters (MPCs) 531. The MPC(s) 531 may include a processing cluster that be, in embodiments, more versatile than a GPU, and with higher efficiency than a CPU. For example, the MPC(s) 531 may include a multi-threaded processor that allows multiple threads to share resources and execute instructions concurrently.

The SoC(s) 504 may include one or more programmable macro arrays (PMA(s)) 535. The PMA(s) 535 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 504 may include one or more display processing units (DPUs) 545 for performing hardware-accelerated image processing. For example, the DPU(s) 545 may retrieve pixel data from memory 515 and send it to a display peripheral through standard interfaces. As such, the DPU(s) 545 may handle display processing and rendering for in-machine and/or on-machine displays.

The SoC(s) 504 may include one or more application processing units (APUs) 539. For example, the APU(s) 539 may include a quad or dual-core processor with 48 KB/32 KB L1 cache with parity and ECC, along with a 1 MB L2 cache with ECC. The APU(s) 539 may support NEON instructions and single and double precision floating point operations.

The SoC(s) 504 may include one or more real-time processing units (RTPUs) 569. The RTPU(s) 569 may include a dual-core processor with 32 KB/32 KB L1 cache, and 256 KB TCM with ECC. The RTPU(s) 569 may support single and double precision floating point operations.

The SoC(s) 504 may include one or more built-in self-test (BIST) components 537. For example, the BIST component(s) 537 may include memory BIST (MBIST) to test memories of the system and/or logic BIST (LBIST) to test logic of the system. The BIST components 537 may include embedded logic for directly testing logic and/or memory of the system.

The SoC(s) 504 may include one or more dynamically reconfigurable processors (DRPs) 571. For example, the DRP(s) 571 may be used for accelerating various computing operations. For example, the DRP(s) 571 may be combined, in embodiments, with a MAC unit for use as an AI accelerator. In embodiments, the DRP(s) 571 may execute applications while dynamically switching the circuit connection configuration of the arithmetic units (e.g., ALUs) on the chip at each operating clock according to the content to be processed. Since only the necessary arithmetic circuits are used, the DRP(s) 571 may consume less power than with CPU processing and can achieve higher speed. Furthermore, compared to CPUs, where frequent external memory accesses due to cache misses and other causes will degrade performance, the DRP(s) 571 can build the necessary data paths in hardware ahead of time, resulting in less performance degradation and less variation in operating speed (jitter) due to memory accesses. The DRP(s) 571 may include a dynamic loading function that switches the circuit connection information each time the algorithm changes, enabling processing with limited hardware resources, even in robotic/automotive applications that require processing of multiple algorithms.

In some embodiments, the accelerator(s) 514 may include an OpenCV accelerator for speeding up processing of OpenCV, an open-source industry standard library for computer vision processing. In some embodiments, the combination of one or more DRP(s) 571 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 504 may include various compute engines (e.g., processors 510, CPUs 506, GPU(s) 508, accelerator(s) 514, etc.), tasks may be distributed between and among the compute engines, in some instances without common cause failures due to the discrete footprint of the compute engines. Further, because the SoC(s) 504 may include a dedicated safety processor(s) 513 (or safety island 513), critical safety or redundant operations may be performed without common cause failures from the main processing components or compute engines of the SoC(s) 514. Due to these features, the SoC(s) 504 and/or the underlying systems of the machine 500 may be capable of satisfying higher levels of safety—such as automotive safety integrity level (ASIL) D from the ISO 26262 standard.

FIG. 5E is a system diagram for communication between a cloud-based server(s) (e.g., in a data center, such as those described herein) and the example autonomous or semi-autonomous vehicle or machine 500 of FIG. 5A, in accordance with some embodiments of the present disclosure. The system 576 may include a server(s) 578, a network(s) 590, and a machine(s) 500. The server(s) 578 may include a plurality of GPUs 584(A)-584(H) (collectively referred to herein as GPUs 584), switches 582(A)-582(H) (such as PCIe 4.0/5.0/etc switches, M.2 slots, thunderbolt, USB 4, NVIDIA's NVLink, NVIDIA's NVSwitch, GPUDirect RDMA, GPUDirect Storage, etc.), CPUs 580(A)-580(B) (collectively referred to herein as CPUs 580), accelerators, and/or other processor types. The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the machine(s) 500, sensor data indicating information about new or previously unexplored locations, and/or sensor data indicating changes to previously seen/stored locations (e.g., unexpected or changed road conditions, such as recently commenced road-work). The server(s) 578 may transmit, over the network(s) 590 and to the machine(s) 500, neural networks 592, updated neural networks 592, map information 594, etc., including information regarding traffic and road conditions. The updates to the map information 594 may include updates for the HD map 522, SD map, navigation map, etc., such as information regarding construction sites, potholes, detours, flooding, and/or other obstructions. In some examples, the neural networks 592, the updated neural networks 592, the map information 594, and/or the other information may have resulted from new training and/or experiences represented in data received from any number of machine(s) 500 in the environment, and/or based on training performed at a datacenter (e.g., using the server(s) 578 and/or other servers).

The server(s) 578 may be used to train machine learning models (e.g., neural networks) based on training data. The training data may be generated by the machine(s) 500, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 500 (e.g., transmitted to the machine(s) 500 over the network(s) 590, and/or the machine learning models may be used by the server(s) 578 to remotely monitor and/or control the machine(s) 500.

In some examples, the server(s) 578 may receive data from the machine(s) 500 and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the machine 500. For example, the deep-learning infrastructure may receive periodic updates from the machine 500, such as a sequence of images and/or objects that the machine 500 has located in that sequence of images (e.g., via computer vision and/or other machine learning object classification techniques). The deep-learning infrastructure may run its own neural network to identify the objects and compare them with the objects identified by the machine 500 and, if the results do not match and the infrastructure concludes that the AI in the machine 500 is malfunctioning, the server(s) 578 may transmit a signal to the machine 500 instructing a fail-safe computer of the machine 500 to assume control, notify the passengers, and complete a safety maneuver or operation-such as to slow down, hand control back to a driver, come to a stop, and/or pull over/shut down.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 6 is a system diagram illustrating a three computer ecosystem 600, including a first computing system 602 for generating or creating artificial intelligence (AI)—such as AI training and validation data, a second computing system 604 for training artificial intelligence, and a third computing system 606 (which may include or correspond to the SoC(s) 504 of FIGS. 5A-5E) deploying the AI at the edge, in accordance with at least some embodiments of the present disclosure. For example, to develop and deploy embodied or physical AI, the three computer ecosystem 600 may be used, including three accelerated computer systems to handle physical AI training, simulation, and runtime (e.g., edge deployment). These systems may generate training data for and train multimodal foundation models (and/or other model types) using scalable, physically based simulations of the machine(s) 500 and their worlds. By doing so, simulation of machine(s) 500 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 500 can perform safely in controlled settings.

The computing system 604 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 500 to understand natural language and emulate movements by observing human actions. The computing system 604 may include a platform that incorporates software, infrastructure, and expertise in a modern, unified AI development and training solution. The computing system 604 may include individual computing devices 610 (e.g., NVIDIA's DGX B200, H200, etc.) and/or any number of computing devices 610 in a data center infrastructure 612 (e.g., NVIDIA's DGX SuperPOD).

For example, the individual computing devices 610 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 610 may include memory (e.g., 4 TB memory, and storage (e.g., OS storage of 2×1.9 TB NVMe M.2, and internal storage of 8×3.84 TB NVMe U.2). The computing devices 610 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 610 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 610 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 610 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 610 may include a smart host channel adapter (HCA) (e.g., NVIDIA's ConnectX-7) to provide ultra-low latency, 400 Gb/s throughput for in-network computing acceleration engines.

The data center infrastructure 612 may include any number of the computing devices 610, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 610) to thousands, job scheduling and orchestration to ensure hassle-free execution of every developer's job, AI workflow management and machine learning operations (MLOps) to move more models from prototype to production, and enterprise software to speed developer success.

The computing system 602 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 602 allows developers to use simulation frameworks to simulate and validate robot models, and/or to generate massive amounts of physically-based synthetic data to bootstrap model training. The computing system 602 may support learning frameworks that power robot reinforcement learning and imitation learning, to accelerate robot policy training and refinement. For example, the computing system 602 may be used to generate any number of simulations 608—such as within NVIDIA's OMNIVERSE. The computing system 602 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 602 may host or support a native OpenUSD software platform enabling enterprises to connect 3D pipelines and develop advanced, real-time 3D applications for industrial digitalization. With powerful ray-tracing-accelerated AI and graphics capabilities, the computing system 602 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 602 may include individual computing devices 614 (e.g., NVIDIA's OVX L40S Server) and/or any number of computing devices 614 in a data center infrastructure 616 (e.g., NVIDIA's OVX Systems).

The computing device(s) 614 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen 4× 16:64 GB/s bidirectional interconnect interface, 18,176 CUDA cores, 142 ray tracing (RT) cores, and 568 tensor cores). The computing devices 614 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 614 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 614 may include a smart host channel adapter (HCA) (e.g., NVIDIA's ConnectX-7) to provide ultra-low latency, 400 Gb/s throughput for in-network computing acceleration engines. The computing device(s) 614 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 612, the data center infrastructure 616 may allow for any number of computing device(s) 614 to be combined in cluster configuration according to a reference architecture.

The computing system 606 may be used to deploy trained AI models on a runtime computer—such as the SoC(s) 504 described herein. For example, these computing systems 606 may be designed for compact, on-board computing needs, including an ensemble of models for control policy, vision and language models, etc., deployed on a power-efficient on-board edge computing system 606. Details of components, features, and capabilities of the computing system 606 may be described in more detail herein with respect to FIGS. 5A-5E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7 is a block diagram of an example generative language model system 700 suitable for use in implementing at least some embodiments of the present disclosure. In the example illustrated in FIG. 7, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a MMLM, a VLA model, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization (TN), for example, by converting all characters to lowercase, removing accents, and/or or handling special cases like contractions or abbreviations to ensure consistency (e.g., converting ¼ to one quarter). Similarly, the input processor 705 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features-such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s), speaker(s), etc.), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

Example 1. A method comprising:
performing, by an ego-machine, one or more operations in a remote operating mode based at least on one or more remote control commands wirelessly received via a wireless communication system of the ego-machine;
disabling a remote control system of the ego-machine in response to a switch command to switch the ego-machine from operating in the remote operating mode to operating in a local operating mode, the disabling including blocking or disabling at least wireless communications from reaching the remote control system of the ego-machine; and
performing, by the ego-machine, one or more local operations in the local operating mode based at least on one or more local control commands.

The method of Example 1, wherein the remote operating mode includes a remote parking mode.

The method of Example 1, wherein the local operating mode includes a local driving mode.

The method of Example 1, wherein the remote control system operates using a first processor pool of a processor associated with the ego-machine, and a main control system of the ego-machine operates using a second processor pool of the processor.

The method of Example 1, further comprising:
prior to performing, by the ego-machine, the one or more operations in the remote operating mode:
determining whether the remote control system was disabled in a controlled manner in a most recent prior attempt to disable the remote control system.

The method of Example 1, further comprising:
in response to determining that the remote control system was not disabled in a controlled manner in the most recent prior attempt to disable:
indicating that the one or more operations are not available.

The method of Example 1, further comprising:
in response to determining that the remote control system was disabled in a controlled manner in the most recent prior attempt to disable:
enabling the remote control system;
switching from the local operating mode to the remote operating mode; and
performing the one or more operations in the remote operating mode.

The method of Example 1, wherein disabling the remote control system comprises:
verifying that the remote control system has been disabled based at least on one or more of a predefined time limit associated with a corresponding disablement process or a receipt of a completion message indicating completion of the disablement process.

The method of Example 1, wherein disabling the remote control system includes disabling one or more physical components of the remote control system.

The method of Example 1, wherein the remote control system and a main control system of the ego-machine are implemented using respective virtual machines (VMs).

Example 2. A system comprising:
one or more processors to cause performance of operations comprising:
performing, by an ego-machine, one or more operations in a remote operating mode based at least on one or more remote control commands wirelessly received via a wireless communication system of the ego-machine;
disabling a remote control system in response to a switch command to switch the ego-machine from operating in the remote operating mode to operating in a local operating mode; and
performing, by the ego-machine, one or more local operations in the local operating mode based at least on one or more local control commands.

The system of Example 2, wherein the remote operating mode includes a remote parking mode.

The system of Example 2, wherein the local operating mode includes a local driving mode.

The system of Example 2, wherein the remote control system operates using a first processor pool of a processor associated with the ego-machine, and a main control system of the ego-machine operates using a second processor pool of the processor.

The system of Example 2, the operations further comprising:
prior to performing, by the ego-machine, the one or more operations in the remote operating mode:
determining whether the remote control system was disabled in a controlled manner in a most recent prior attempt to disable the remote control system.

The system of Example 2, the operations further comprising:
in response to determining that the remote control system was not disabled in a controlled manner in the most recent prior attempt to disable:
indicating that the one or more operations are not available.

The system of Example 2, the operations further comprising:
in response to determining that the remote control system was disabled in a controlled manner in the most recent prior attempt to disable:
enabling the remote control system;
switching from the local operating mode to the remote operating mode; and
performing the one or more operations in the remote operating mode.

The system of Example 2, wherein disabling the remote control system comprises:
verifying that the remote control system has been disabled based at least on one or more of a predefined time limit associated with a corresponding disablement process or a receipt of a completion message indicating completion of the disablement process.

The system of Example 2, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or a system implemented at least partially using cloud computing resources.

Example 3. One or more processors comprising:
processing circuitry to cause performance of operations comprising:
performing, by an ego-machine, one or more operations in a remote operating mode based at least on one or more remote control commands wirelessly received via a wireless communication system of the ego-machine;
disabling a remote control system in response to a switch command to switch the ego-machine from operating in the remote operating mode to operating in a local operating mode; and
performing, by the ego-machine, one or more local operations in the local operating mode based at least on one or more local control commands.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method comprising:
performing, by an ego-machine, one or more operations in a remote operating mode based at least on one or more remote control commands wirelessly received via a wireless communication system of the ego-machine;
disabling a remote control system of the ego-machine in response to a switch command to switch the ego-machine from operating in the remote operating mode to operating in a local operating mode, the disabling including preventing wireless communications received via the wireless communication system from reaching the remote control system of the ego-machine; and
performing, by the ego-machine, one or more local operations in the local operating mode based at least on one or more local control commands.

2. The method of claim 1, wherein the remote operating mode includes a remote parking mode.

3. The method of claim 1, wherein the local operating mode includes a local driving mode.

4. The method of claim 1, wherein the remote control system operates using a first processor pool of a processor associated with the ego-machine, and a main control system of the ego-machine operates using a second processor pool of the processor.

5. The method of claim 1, further comprising:
prior to performing, by the ego-machine, the one or more operations in the remote operating mode:
determining whether the remote control system was disabled in a controlled manner according to a designated shutdown process in a most recent prior attempt to disable the remote control system.

6. The method of claim 5, further comprising:
in response to determining that the remote control system was not disabled in a controlled manner in the most recent prior attempt to disable:
indicating that the one or more operations are not available.

7. The method of claim 5, further comprising:
in response to determining that the remote control system was disabled in a controlled manner in the most recent prior attempt to disable:
enabling the remote control system;
switching from the local operating mode to the remote operating mode; and
performing the one or more operations in the remote operating mode.

8. The method of claim 1, wherein disabling the remote control system comprises:
verifying that the remote control system has been disabled based at least on one or more of a predefined time limit associated with a corresponding disablement process or a receipt of a completion message indicating completion of the disablement process.

9. The method of claim 1, wherein disabling the remote control system includes disabling one or more physical components of the remote control system.

10. The method of claim 1, wherein the remote control system and a main control system of the ego-machine are implemented using respective virtual machines (VMs).

11. A system comprising:
one or more processors to cause performance of operations comprising:
performing, by an ego-machine, one or more operations in a remote operating mode based at least on one or more remote control commands wirelessly received via a wireless communication system of the ego-machine, the one or more remote control commands communicated to a main control system of the ego-machine via a remote control system of the ego-machine;
disabling the remote control system of the ego-machine in response to a switch command to switch the ego-machine from operating in the remote operating mode to operating in a local operating mode, the disabling of the remote control system being such that subsequent remote control commands subsequently received via the wireless communication system are blocked by the remote control system from being received by the main control system; and
performing, by the ego-machine, one or more local operations in the local operating mode based at least on one or more local control commands.

12. The system of claim 11, wherein the remote operating mode includes a remote parking mode.

13. The system of claim 11, wherein the local operating mode includes a local driving mode.

14. The system of claim 11, wherein the remote control system operates using a first processor pool of a processor associated with the ego-machine, and a main control system of the ego-machine operates using a second processor pool of the processor.

15. The system of claim 11, the operations further comprising:
prior to performing, by the ego-machine, the one or more operations in the remote operating mode:
determining whether the remote control system was disabled in a controlled manner that follows a designated shutdown process in a most recent prior attempt to disable the remote control system.

16. The system of claim 15, the operations further comprising:
in response to determining that the remote control system was not disabled in a controlled manner in the most recent prior attempt to disable:
indicating that the one or more operations are not available.

17. The system of claim 15, the operations further comprising:
in response to determining that the remote control system was disabled in a controlled manner in the most recent prior attempt to disable:
enabling the remote control system;
switching from the local operating mode to the remote operating mode; and
performing the one or more operations in the remote operating mode.

18. The system of claim 11, wherein disabling the remote control system comprises:
verifying that the remote control system has been disabled based at least on one or more of a predefined time limit associated with a corresponding disablement process or a receipt of a completion message indicating completion of the disablement process.

19. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

20. One or more processors comprising:
processing circuitry to cause performance of operations comprising:
performing, by an ego-machine, one or more operations in a remote operating mode based at least on one or more remote control commands wirelessly received via a wireless communication system of the ego-machine, the ego-machine performing the one or more operations based at least on a remote control system of the ego-machine relaying the one or more remote control commands for execution by one or more elements of the ego-machine;
disabling a remote control system of the ego-machine in response to a switch command to switch the ego-machine from operating in the remote operating mode to operating in a local operating mode, the disabling of the remote control system being such that subsequent remote control commands subsequently received via the wireless communication system are omitted from being relayed by the remote control system; and
performing, by the ego-machine, one or more local operations in the local operating mode based at least on one or more local control commands.
